(19) United States
(12) Patent Application Publication
(10) Pub. No.: US 2013/0073420 A1
(43) Pub. Date: Mar. 21, 2013

(54) System and Method for Interior Design

(71) Applicants: Michael R. Kumm, Redford, MI (US); Jennifer Gilbert, Franklin, MI (US); Kevin A. Goddard, Troy, MI (US); Fernando Prieto Paricio, Rochester Hills, MI (US)

(72) Inventors: Michael R. Kumm, Redford, MI (US); Jennifer Gilbert, Franklin, MI (US); Kevin A. Goddard, Troy, MI (US); Fernando Prieto Paricio, Rochester Hills, MI (US)

(73) Assignee: Doodle Enterprises LLC, Detroit, MI (US)

(21) Appl. No.: 13/601,550

(22) Filed: Aug. 31, 2012

Related U.S. Application Data
(60) Provisional application No. 61/536,884, filed on Sep. 20, 2011.

(51) Int. Cl. G06Q 30/00

(52) U.S. Cl. 705/26.5; 705/26.8; 705/27.2

(57) ABSTRACT

A method of collaborative interior design between users on a displayed graphical user interface includes for each user, displaying on the graphical user interface a first list of design elements retrieved from a remote third-party data sources and a second list of design elements retrieved from a service provider data source. The method further includes receiving a placement of a design element from one of the design element lists in an interactive view of the graphical user interface by at least one of the users, and displaying an arrangement of design elements placed in the interactive view. The method includes executing on a computing processor an information acquisition routine that determines purchasing information for design elements of the first list placed in the interactive view, and displaying a shopping list populated with at least some of the design elements placed in the interactive view.

This U.S. patent application claims priority under 35 U.S.C. §119(e) to U.S. Provisional Application 61/536,884, filed on Sep. 20, 2011, which is hereby incorporated by reference in its entirety.

### TECHNICAL FIELD

This disclosure relates to systems and methods for interior design.

### BACKGROUND

Interior design generally involves turning an interior space into an effective setting for a range of human activities. Historically, an interior designer typically conducts such a project through conceptual development, liaising with stakeholders of the project and managing execution of a design.

### SUMMARY

One aspect of the disclosure provides a method of collaborative interior design between users on a displayed graphical user interface. The method includes for each user, displaying on the graphical user interface a first list of design elements retrieved from remote third-party data sources and a second list of design elements retrieved from a service provider data source. The method further includes receiving a placement of a design element from one of the design element lists in an interactive view of the graphical user interface by at least one of the users, and displaying an arrangement of design elements placed in the interactive view. The method includes executing on a computing processor an information acquisition routine that determines purchasing information for design elements of the first list placed in the interactive view, and displaying a shopping list populated with at least some of the design elements placed in the interactive view.

A computer program product encoded on a non-transitory computer readable storage medium may include instructions that when executed by a data processing apparatus cause the data processing apparatus to perform the method of collaborative interior design described above.

In some examples, the method further includes displaying on the graphical user interface a series of images, receiving a user style input with respect to each image, and determining the user style based on the user style inputs. The method may include displaying a third list of design elements, each having a style matching the received at least one style of the corresponding user.

In some examples, the method includes receiving a design project profile, receiving at least one preference associated with each user, and determining the second list of design elements based on the style associated with each user, the user preference, and the project profile. The method may execute a search heuristic on a collection of possible combinations of design elements and select a combination of design elements based on a probability of combination using at least one style associated with each user, at least one preference associated with each user, and the design project profile.

Additionally or alternatively, displaying the second list of design elements may include for each user, retrieving design elements identified as liked-elements from the service provider data source. Displaying the first list of design elements may include for each user, retrieving design elements identified as liked-elements from the third-party service provider. In some examples, the method further includes receiving information from the remote third-party data sources regarding at least one of a price, a color, a color pallet, or dimensions. Displaying the shopping list may include acquiring purchasing information from the remote third-party data source and displaying on the graphical user interface an option to view the acquired purchasing information.

In some implementations, the method includes taking a still image of the interactive view. The method may include identifying a design element and moving design element forward or backward with respect to another design element and/or rotating the design element.

Another aspect of the disclosure provides an interior design system that includes a client style, a client preference, a project profile, and a project design engine executing on a computing processor and in communication with the client style, the client preference, and the project profile. The project design engine determines a project design based on the client style, the client preference, and the design project profile.

Implementations of the disclosure may include one or more of the following features. In some implementations, the client style includes a programmatic object stored in memory and having one or more properties. The client style may include at least one of contemporary, traditional, Asian, classical, arts & crafts, country, art deco, gothic, tropical, rustic, Tuscan, Swedish, Southwestern, minimalist, cool minimalism, country fresh, easy transitional, edgy glam, effortless eclectic, industrial chic, not your mother's traditional, and warm contemporary. Other styles are possible as well. In some examples, the client style includes a weighted average of ranked images.

The client preference may be a programmatic object stored in memory and having one or more properties. In some examples, the client preference includes at least one of a weighted list of client styles, a budget range, a maximum budget threshold, a minimum budget threshold, a client income, a client family status, a client family size, a number of viewings of one or more pieces of furniture, or a browsing history of pieces of furniture.

In some implementations, the project design engine executes a search heuristic on a collection of possible combinations of design elements and selects a combination of design elements based on a probability of combination using the client style, the client preference, and the design project profile. The project design engine may select the combination of design elements based on client-designer interactions and/or a browsing history of design elements. The design element may include at least one of a piece of furniture, a color, a color scheme, wall decor, a window treatment, or a floor covering.

In some implementations, the interior design system includes a client shopping cart. The client shopping cart displays a list of selected design elements. Additionally or alternatively, at least one selected design element may include information retrieved from a service provider data source or a third-party data provider data source (e.g., price, color or color pallet, and dimensions).

Another aspect of the disclosure provides a method of interior design. The method includes receiving a client style, receiving a client preference, receiving a design project profile, and executing a routine on a computing processor to determine a project design based on the client style, the client preference, and the project profile.

A computer program product encoded on a non-transitory computer readable storage medium may include instructions that when executed by a data processing apparatus cause the data processing apparatus to perform the method of interior design described above.

In some implementations, the client style includes a programmatic object stored in memory and having one or more properties. The client style may include at least one of contemporary, traditional, Asian, classical, arts & crafts, country, art deco, gothic, tropical, rustic, Tuscan, Swedish, Southwestern, or minimalist, cool minimalism, country fresh, easy transitional, edgy glam, effortless eclectic, industrial chic, not your mother's traditional, and warm contemporary.

In some examples, the method includes displaying a series of design elements (e.g., photographs of design elements or combinations thereof), receiving a user style input with respect to each design element, and determining the client style based on the user inputs. The method may include receiving a client ranking of each design element and determining the client style based a weighted average of the ranked design elements.

The client preference may be a programmatic object stored in memory and having one or more properties. In some examples, the client preference includes at least one of a weighted list of client styles, a budget range, a maximum budget threshold, a minimum budget threshold, a client income, a client family status, a client family size, a number of viewings of one or more pieces of furniture, or a browsing history of pieces of furniture.

In some implementations, the method includes executing a search heuristic on a collection of possible combinations of design elements and selecting a combination of design elements based on a probability of combination using the client style, the client preference, and the project profile. The method may also include selecting the combination of design elements based on client-designer interactions and/or a browsing history of design elements. The design element may include at least one of a piece of furniture, a color, a color scheme, wall decor, a window treatment, or a floor covering.

Another aspect of the disclosure provides a method of matching a client and a designer for collaborative interior design. The method includes displaying on a graphical user interface a series of images, each image having one or more associated tags. The method also includes receiving at least one image selection from a client, associating the one or more tags associated with the at least one image selection with the client, and receiving profiles of designers, each designer profile having one or more associated tags. The method further includes executing a routine on a computing processor that compares the tags associated with the client with the tags associated with each designer profile to determine a compatibility with at least one designer; and displaying on the graphical user interface a list of one or more compatible designers. In some implementations, the routine determines the compatibility between the client and the designers based on a number of common tags associated with the client and the profiles of the designers.

In some examples, the method includes executing a routine on a computing processor that determines a client style based on the tags associated with the client. The method may further include displaying on the graphical user interface a first list of design elements retrieved from remote third-party data sources, a second list of design elements retrieved from a data source service of a provider, and receiving a placement of a design element from one of the design element lists in an interactive view of the graphical user interface by the designer. The method may include displaying an arrangement of design elements placed in the interactive view, executing on a computing processor an information acquisition routine that determines purchasing information for design elements of the first list placed in the interactive view, and displaying a shopping list populated with at least some of the design elements placed in the interactive view. In some examples, the method includes displaying on the graphical user interface a third list of design elements, each having a style matching the client style. The method may include receiving images captured by the designer and displaying a fourth list of design elements, the list comprising the received uploaded images. In some examples, displaying the first or second list of design elements comprises design elements identified as liked-elements by the client.

In some examples, the method includes receiving information from the remote third-party data sources regarding at least one of a price, a color, a color pallet, or dimensions. Displaying the shopping list may include acquiring purchasing information from the remote third-party data source, and displaying on the graphical user interface an option to view the acquired purchasing information. In some examples, the method further includes capturing an image of the interactive view.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a schematic view of an exemplary overview of the interaction between a client, a design system and designers.

FIG. 1B is a schematic view of an exemplary interior design system allowing the client to choose a designer.

FIG. 2 is a schematic view of an exemplary interior design system allowing the client to view images of designs by a designer.

FIGS. 3A and 3B are schematic views of exemplary style finder views.

FIGS. 4A and 4B are schematic views of exemplary style finder views.

FIGS. 5A and 5B are schematic views of exemplary style finder views for two clients.

FIG. 5C is a schematic view of a style finder decision tree.

FIG. 5D is a schematic view of a style finder elimination process.

FIG. 5E is a schematic view of an exemplary view of an image with tags.

FIG. 6 is a schematic view of an exemplary client preferences view.

FIG. 7 is a schematic view of an exemplary look book view.

FIG. 8 is a schematic view of an exemplary product search view.

FIG. 9 is a schematic view of an exemplary product information view.

FIG. 10 is a schematic view of an exemplary product library.

FIG. 11 is a schematic view of an exemplary client profile board view for displaying the client style and preferences.

FIGS. 12A and 12B are schematic views of exemplary download toolbar view.

FIG. 12C is a schematic view of an exemplary view of elements from another website.

FIG. 12D is a schematic view of an exemplary collect view for collecting design elements from other websites.

FIG. 13A is a schematic view of an exemplary client design board view.

FIG. 13B is a schematic view of the interaction between the client and designer using the client design board of FIG. 15B.

FIGS. 14A and 14B are schematic views of the interaction between the client and designer using the mood board of FIG. 15A.

FIGS. 15 and 16 are schematic views of exemplary mood board views.

FIG. 17 is a schematic view of an exemplary shopping cart view.

FIG. 18 is a schematic view of an exemplary client orders view.

FIG. 19 is a schematic view of an exemplary client orders update.

FIG. 20 is a schematic view of an exemplary arrangement of operations for a method of interior design.

FIG. 21 is a schematic view of an exemplary interior design system.

FIG. 22 is a schematic view of an exemplary interior design system.

FIG. 23 illustrates an exemplary arrangement of operations for a method of interior design.

FIG. 24 is a schematic view of an exemplary arrangement of operations for a method of collaborative interior design

FIG. 25 is a schematic view of an exemplary arrangement of operations for a method of matching a client and a designer for collaborative interior design.

Like reference symbols in the various drawings indicate like elements.

### DETAILED DESCRIPTION

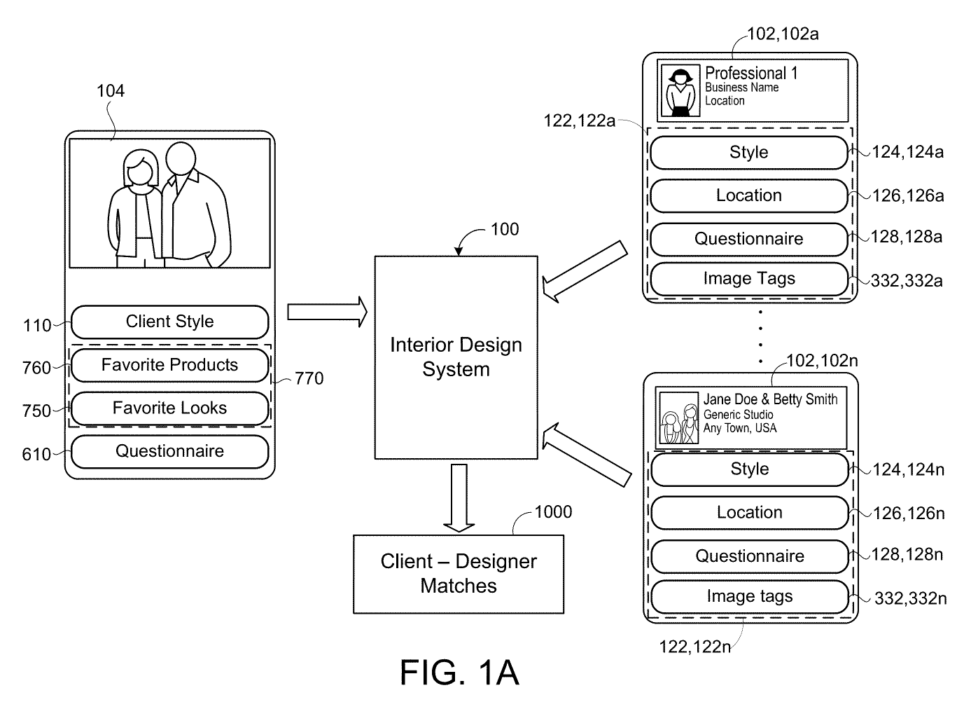

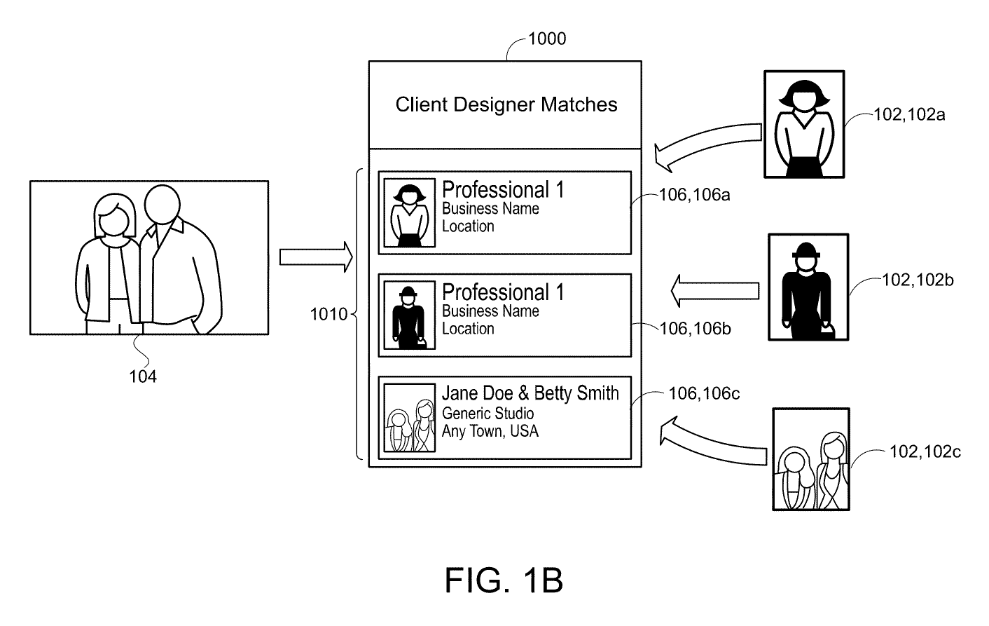

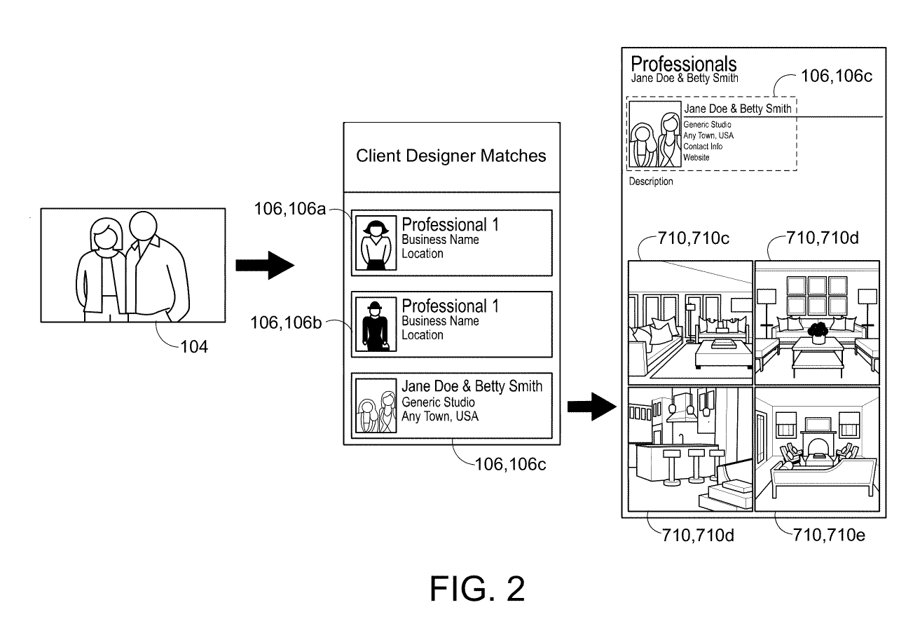

Referring to FIGS. 1A, 1B and 2, in some implementations an interior design system 100 matches a client 104 to a designer 102 using attributes of each of the client 104 and the designer 102. The system 100 considers a client style 110, a favorite list 770 which includes favorite products 760 and favorite design look 750 that the client 104 indicated he/she likes, and responses to a questionnaire 610 that the client 104 answers. The system 100 also considers the designer 102 attributes to provide the client 104 with a list of designers 102 having profiles 122a-n with the same or similar style 110 as the client 104. In some examples, the system 100 considers attributers of a designer 102 such as location, style, and answers to questions. The system 100 provides the client 104 with a list of designers 102 who meet the requirements of the client 104 and who are within the geographical area of the client 104.

Referring to FIG. 1B, in some implementations, the system 100 displays a client-designer matching view 1000 that allows the client 104 to choose a designer 102 from the list that the system 100 has already compiled based on the client style 110, favorite products 760, favorite design look 750, and the response to the questionnaire 610. The system 100 may provide the client 104 with a list 1010 containing designer information 106. The system 1100 may display the information 106 of those designers 102 with the same design style as the client style 110 or designers 102 who previously designed rooms with the specific client style 110. In some examples, the system 100 locates a designer 102 within the same geographical location as the client 104. The client 104 may choose his/her designer 102 based on a geographical location of the designer 102 or the client 104. Therefore, the relationship between the client 104 and the designer 102 may extend beyond the interior design system 100. In some implementations, the client 104 is not limited by the designers 102 in his/her area (location) and can choose from designer 102 located in any city, worldwide.

Referring to FIG. 2, in some implementations, the system 100 allows the client 104 to interact with different designers 102 to pick his/her furniture. The system 100 provides information 106 about the different designers 102. The client 104 may select a designer 106c and view photographs 710c-e of designed rooms that he/she designed. In some examples, the system 100 allows the client 104 to choose and interact with different designers 102 based on his/her specific style and the location he/she lives in to determine the design that fits the personality of the client 104.

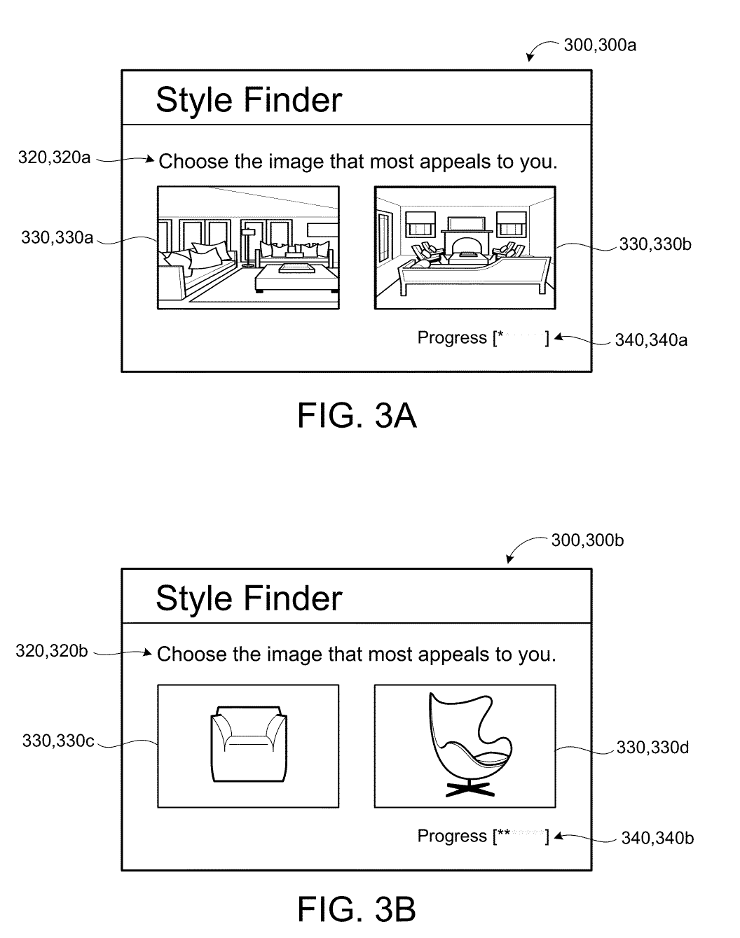

Referring to FIGS. 3A-5C, in some implementations, the client style 110 is determined by scoring answers to a quiz (e.g., an online quiz). The quiz may provide a series of images 330 (e.g., of design elements or combinations of design elements, such as rooms, pieces of furniture, color schemes, etc.) or questions assessed by a quiz taker, such as the designer 102 or the client 104.

The client 104 may select images that he/she prefers over other images and/or rate or rank the images independently or with respect to the others. For example, the client style 110 may be a weighted average of the ranked images or design elements. The system 100 may provide the client 104 with a series of views, each having one or more quiz questions 320 to acquire the client style 110. In some examples, the style finder view 300 arranges images 330 (e.g., photographs or glyphs) on one page allowing the client 104 to view all images 330 that he/she needs to consider for making a selection. The style finder view 300 may display two images 330 as shown in 300a, 300b or four images 330 arranged in a 2×2 configuration as shown in 300c, 300d, 300e, 300f. In some examples, the style finder view 300 may arrange the images 330 in any of the following configurations depending on the number of images the system 100 is displaying: 2×2, 4×4, 2×3, and 3×2. Other arrangements or configurations are possible as well.

A progress indicator 340 may notify the client 104 of his/her progress regarding the total number of questions 320 and/or images 330 he/she needs to answer or view. In some examples, the progress indicator 340 has a predetermined set of bars 340a that increases once the client 104 answers a question 320. The progress indicator 340 may be a counter 342 for counting the total number of questions answered out of the total number of questions 320 and/or images 330. In some examples, the progress indicator 340 is an expanding progress bar 340b that expands once the client 104 answers a question 320 and/or chooses an image 330. Additionally or alternatively, the progress indicator 340 is a combination of a counter 342 and a progress bar 340b. When the client choses an image 330 out of the available images 330, a new set of images 330 appears and the indicator 340 increases by a unit (e.g., the indicator increases by a number if the indicator is a counter 342, or if the indicator is a progress bar it increased by a one unit scale 340a, 340b).

Referring to FIG. 3A, the style finder view 300 displays a first question 320a and first and second images 330a, 330b to the client 104. FIG. 3B shows a second question 320b (in this case the system 100 asks the same question but with different images 330 each time) and third and fourth images 330c, 330d. The progress bar 340 increases from one a one unit scale progress bar 340a in FIG. 3A to a two unit scale progress bar 340b in FIG. 3B, indicating that the client 104 completed the first question 320a.

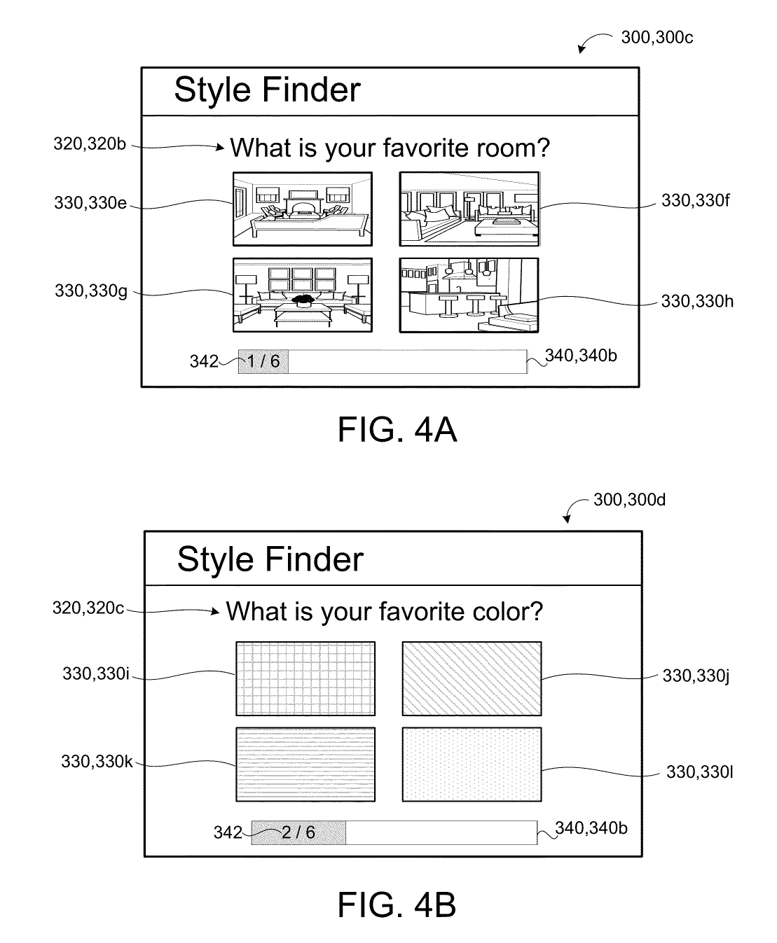

In sonic examples, as shown in FIGS. 3A and 3B, the style finder 300 prompts the client 104 to choose the image 330 that most appeals to him/her. The client 104 chooses one of two images 330a, 330b and is then prompted with the same question 320a but with two new images 330c, 330d. The style finder 300 displays a status 340a of how many questions have been completed. After several prompts (e.g., 3+), the style finder 300 provides the client 104 with his/her style 110. In some examples, as shown in FIGS. 4A and 4B, the style finder 300 prompts the client 104 to answer different questions 320b, 320c each time a question 320 is displayed with corresponding images 330, 330e-i. The questions may include: “What is your favorite room?” or “What is your favorite color?” with corresponding images 330, 330e-i of which the user selects one.

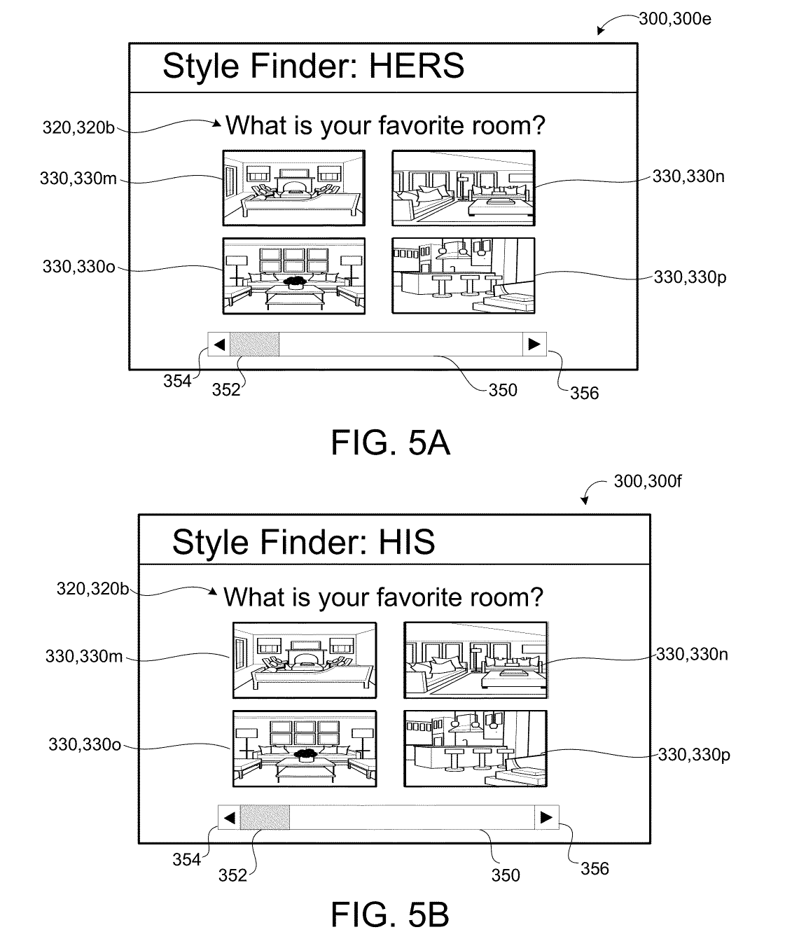

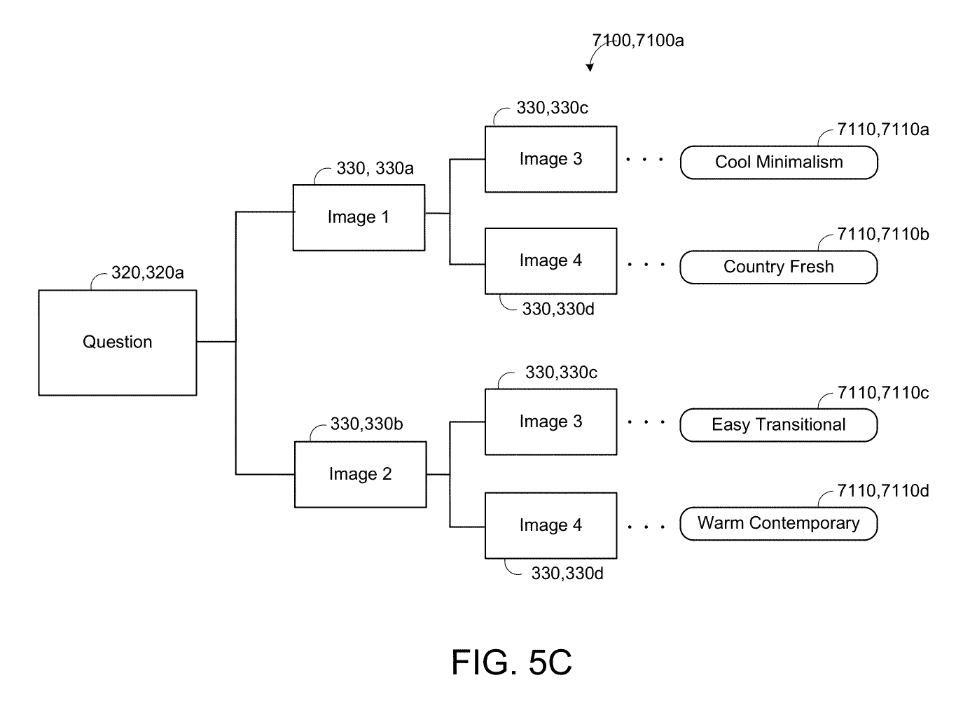

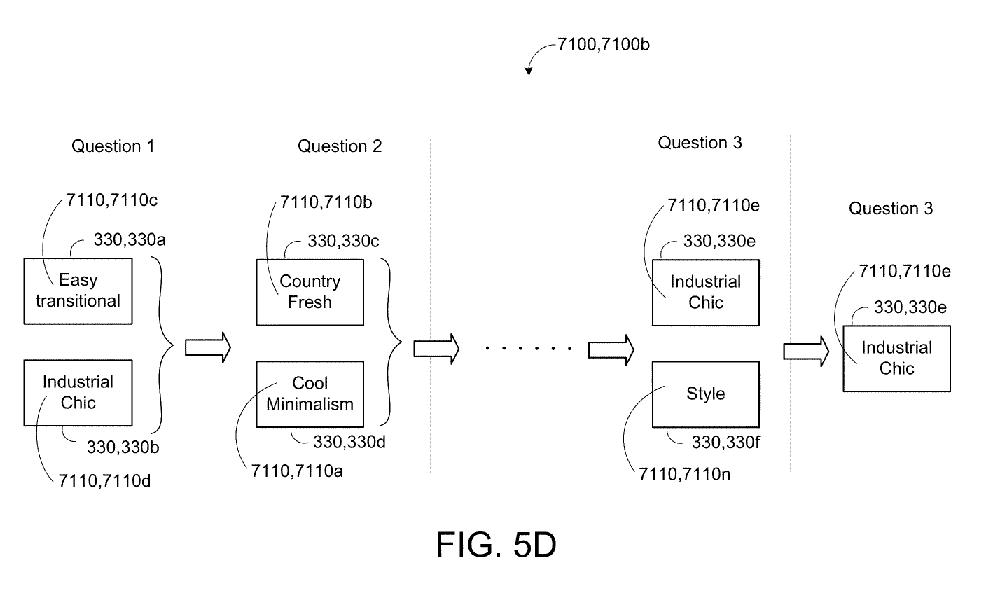

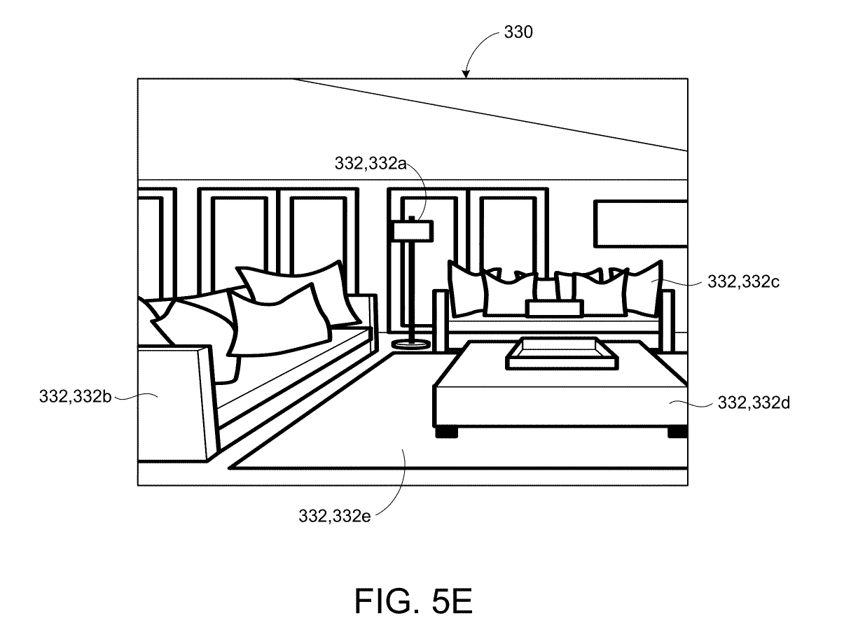

Referring to FIGS. 5A and 5B, in some implementations, two clients 104 sharing a house want to design a room by combining both their styles. The style finder view 300e, 300f prompts each of the clients 104 to answer questions 320 of a quiz separately. The style finder 300e, 300f determines the client style 110 by scoring the answers to the combined quiz of each of the two clients 104. The project design engine 140 uses the combined client style 110 to select design elements 152 for the clients 104. In some implementations, the style finder view 300 provides the client 104 with several images 330 that cannot be displayed all in one view. The style finder 300 displays a series of images 330 horizontally or vertically with a horizontal or vertically bar 350 respectively located either under or over the series of images 330. The client 104 may look through the images 330 by moving a scrollbar 352 located within the bar 350 from left to right, or from right to left. A scroll arrow pointing to the left 354 may be located at the left end of the bar 350, and another arrow pointing to the right 356 may be located at the right end of the bar 350. The client 104 may click the arrows 354 or 356 and scroll through the images, instead of using the scrollbar 352.

Referring to FIG. 5C, in some implementations, the system 100 decides what client style 110 fits a client 104 by using a predetermined decision tree 7100a. The system 100 provides the client 104 with a question 320a and gives the client 104 two options 330a and 330b to choose from. In some examples, the system 100 asks the client 104 to pick which image appeals to him/her more. The client 104 picks between a first image 330a and a second image 330b. The system 100 may ask the client 104 the same or a different question 320 and provide the client 104 with another set of answers 330c and 330d. Based on each image chosen by the client 104, the system 100 follows the decision tree 7100 and decides which style fits the client 104. The client style 110 may include at least one of contemporary, traditional, Asian, classical, arts & crafts, country, art deco, gothic, tropical, rustic, Tuscan, Swedish, Southwestern, or minimalist, cool minimalism 7110a, country fresh 7110b, easy transitional 7110c, edgy glam, effortless eclectic, industrial chic, not your mother's traditional, and warm contemporary 7110d. Other design styles 7110 may be considered.

Referring to FIG. 5D, in some implementations, the system 100 decides what client style 110 fits a client 104 by a process of elimination 7100b. The system 100 provides the client 104 with a first question giving him/her the option to choose between two images 330a, 330b having different styles 7110c, 7110d. Once the client 104 makes his/her selection, the system 100 will no longer display images 330 having the non-selected selected style(s) 7110 (e.g., if the client chooses an image 330a having an easy transitional style 7110c, the system 100 will not provide the user with images 330 in subsequent questions having the non-selected industrial chic style 7710d). With every question 320, the system 100 eliminates one of the styles 7110, narrowing the number of styles 7110 possibly attributable to the client 104. The system 100 decides the client style 110 when there is only one style 7110 left from the elimination process.

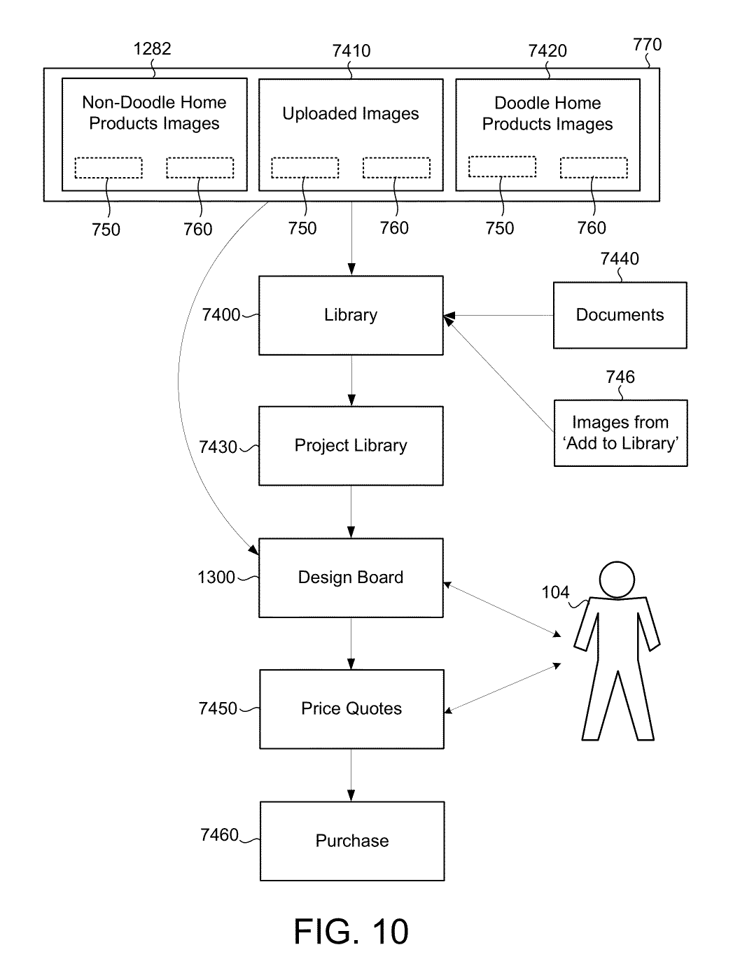

Referring to FIG. 5E, in some implementations, the system 100 associates a tag 332 with design elements 152 within an image 330 of a space that the client 104 chooses. Different images 330 may be used, and may not include design elements 152. The tags 332 may include information relating to the design style of the space, the material and fabrics used in designing the space, and the color palette. The system 100 considers all the tags 332 of the images 330 selected by the client 104 and chooses the list 1010 of designers 102 who have the same design inspirations as the client 104. In some implementations, all the images 330 from a client profile board 1100 and any tags 332 associated with the images 330 are used to match a designer 102 with a client 104. In some examples, each designer has a designer profile 122 which includes a designer style 124, a location 126, answers to a questionnaire 128, and image tags 332 associated with images 330 in the library 7400 (See FIG. 10) of the designer 102. Other attributes may be included in the designer profile. Additionally or alternatively, the system compares the tags 332 associated with the client 104 with the tags 332 associated with each designer profile 122 to determine which designers 102 are compatible with the client 104.

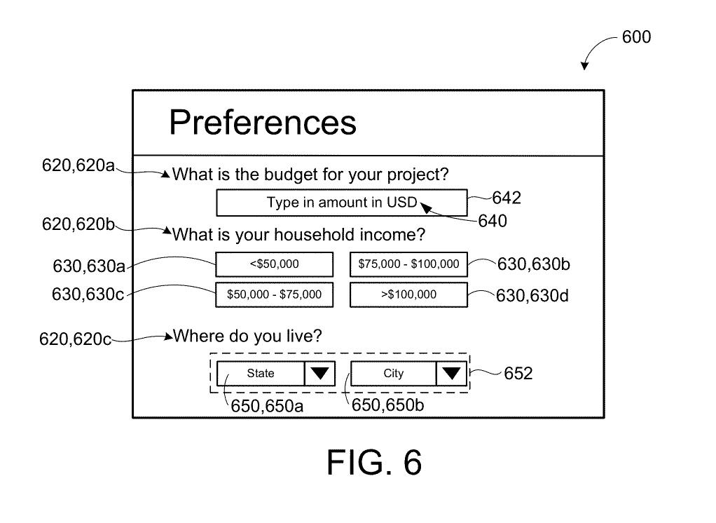

Referring to FIG. 6, in some implementations, client preferences 120 may include one or a combination of client specific traits, such as, but not limited to, a weighted list of client styles, a budget range, maximum and/or minimum budget thresholds, a client age or age range, a client income, a client family status, a client family size, a number of viewings of one or more pieces of furniture, a browsing history of pieces of furniture, etc. Other questions regarding the client 104 may be asked to help the designer 102 learn about the client 104 and what he/she wants. In some examples, the preferences view 600 provides the client 104 with a questionnaire 610 having a series of questions 620 to gather the specific traits of the client 104. The questions 620 may include selectable responses or answers 630,640,650, where the client 104 picks an answer 630,640,650 which he/she thinks best describes his/her traits. In some examples, the client 104 inputs (types) an answer 640 to a question 620a in an input box 642. The interior design system 100 may display a specific number of buttons for each question 620b where each button represents a predetermined answer 630a-d to the question 620b. In some implementations, the interior design system 100 displays answers 650 in a drop down menu 652 (e.g., selecting city 650a or a state 650b where the client 104 lives).

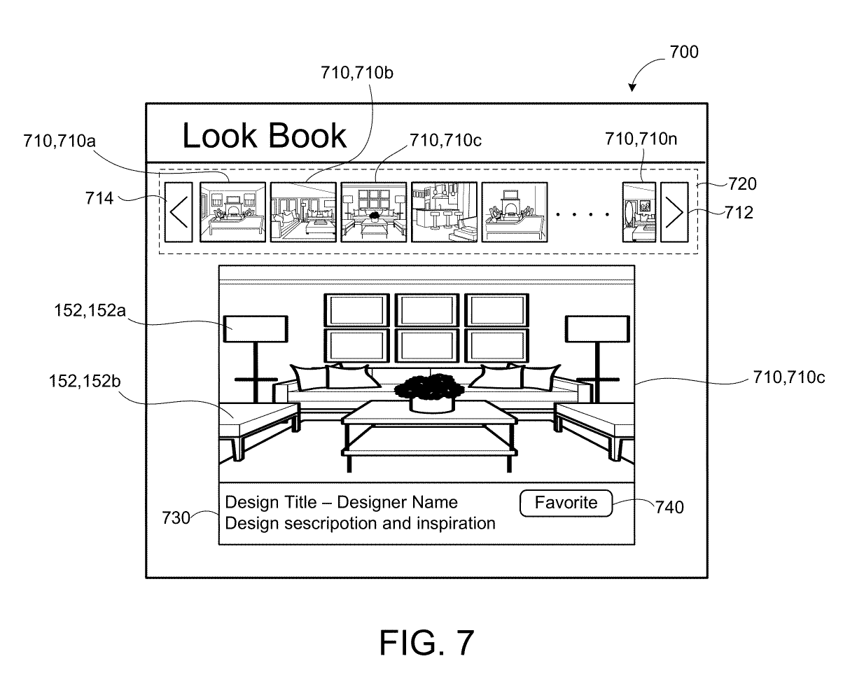

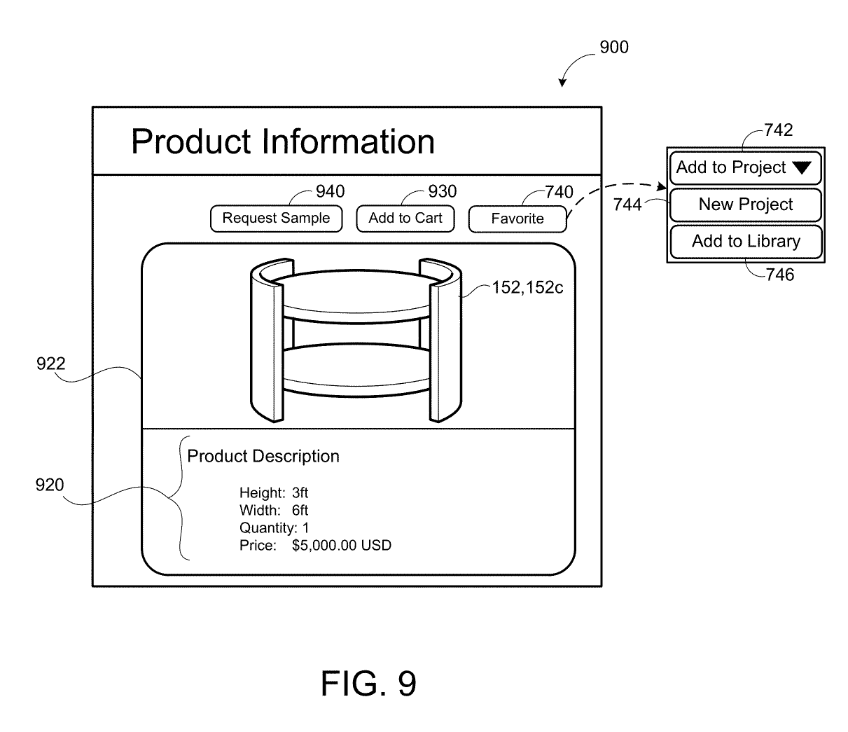

Referring to FIGS. 7, 10, 11 and 17, in some implementations, the client 104 browses images 710 of sample finished designs from several designers 102. The look book view 700 displays a larger view of an image 710c the client 104 selects. The look book view 700 also displays a description 730 of the image 710c. The look book view 700 may have a scrolling list of images 720 where the client 104 selects one of the images 710 to enlarge and view with the description 730. In some examples, a right arrow 712 and a left arrow 714 are located on either side of the photograph list allowing the client 104 to scroll through the images 710. In some examples, the system 100 displays a favorite button 740 (such as a heart shape, a plus button, or other shaped button or image indicating that the client likes what is shown) which allows the client 104 to add the specific design element 152 or the specific designer style to a client profile board 1100 having the client's style items and designs. The system 100 may add the favorite button 740 to views having a design element 152 (e.g., chair, table, sofa, etc.) or a designer style (e.g., look book). The client 104 may select the favorite button 740. In some examples, when the designer 102 selects a design element 152 to add to a favorite list 770 the designer 102 has the option to add the design element 152 to an existing project 742 for one of his/her clients 104, the designer 102 can create a new project 744 and add the design element 152 to a newly created project 744, or add the design element 152 to a library 7400 (see FIGS. 9 and 10). In some examples, when the client 104 selects a sample design image 710, the client views a larger image of the photograph, a description of the photograph, and a list of the design elements used in the photograph. The client 104 may select a design element 152 (e.g., the lamp 152a or the chair 152b) and either add it to his/her shopping cart 1700, or select the favorite button 740 to add it to his/her client profile board 1100. In some implementations, the client 104 sorts the images 710 by color theme, designer 102, room type (e.g., living room, bedroom, kitchen, etc.), or by designers in his/her location.

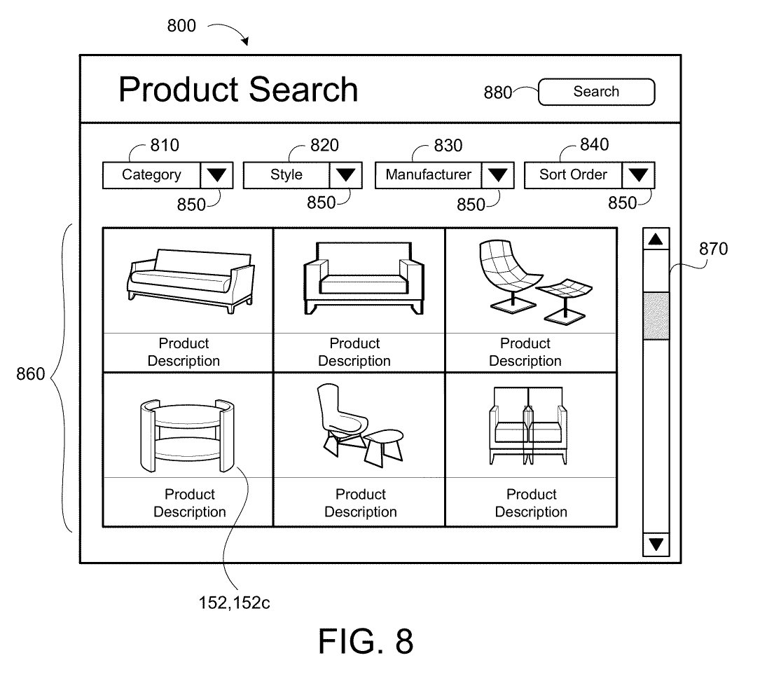

Referring to FIGS. 8, 9 and 11, in sonic implementations, when the style finder 300 determines the client style 110, the client 104 shops for design elements 152 associated with his/her style 110. The client 104 may select design elements 152 from other styles. In some examples, as shown in FIG. 8, the product search view 800 facilitates searching for specific design elements 152. In some examples, the client 104 has several searching options to find design elements 152. The product search view 800 allows the client 104 to filter the design elements 152 based on category 810 (e.g., all categories, accessories, furniture, leather, lighting, rugs, textile, wallpaper, etc.), or style 820 (e.g., cool minimalist, country fresh, easy transitional edgy glam, effortless eclectic, industrial chic, not your mother's traditional, warm contemporary, etc.), and by manufacturer 830. The client 104 may also sort the design elements 152 by a sort order 840, such as price from highest to lowest, or from lowest to highest), by alphabetical order, or by relevancy. The product search view 800 may display each filter or search criteria 810, 820, 830, 840 in a dropdown or combo box 850. In some examples, if the results 860 of the product filtering are too large to view on one view, the product search view 800 displays a scrolling bar 870 allowing the client 104 to scroll through the product search view 800 and see all the results 860. Additionally or alternately, the product search view 800 may include a search box 880 to allow the client 104 or the designer 102 to quickly search for a specific design element 152, color, product material, etc. Referring to FIG. 9, in some examples, the client 104 may select an element 152 (e.g., a coffee table 152c) from the results 860 to view a product information view 900 for more information 920 that relates to the element 152, in this case, a coffee table 152c. The product information view 900 provides detailed information 920 of the element/product 152 such as dimensions, weight, price, detailed description, etc. and/or an image 922 of the element/product 152. The client 104 may select the favorite button 740 to add the coffee table 152c to his/her client profile board 1100. Additionally or alternatively, the client 104 selects an add-to-cart button 930 and proceeds to purchase the coffee table 152c. The client may order a piece of fabric by clicking the request sample button 940. In some examples, the client 104 cannot make purchases through the system 100 and the designer 102 places the orders on behalf of the client 104.

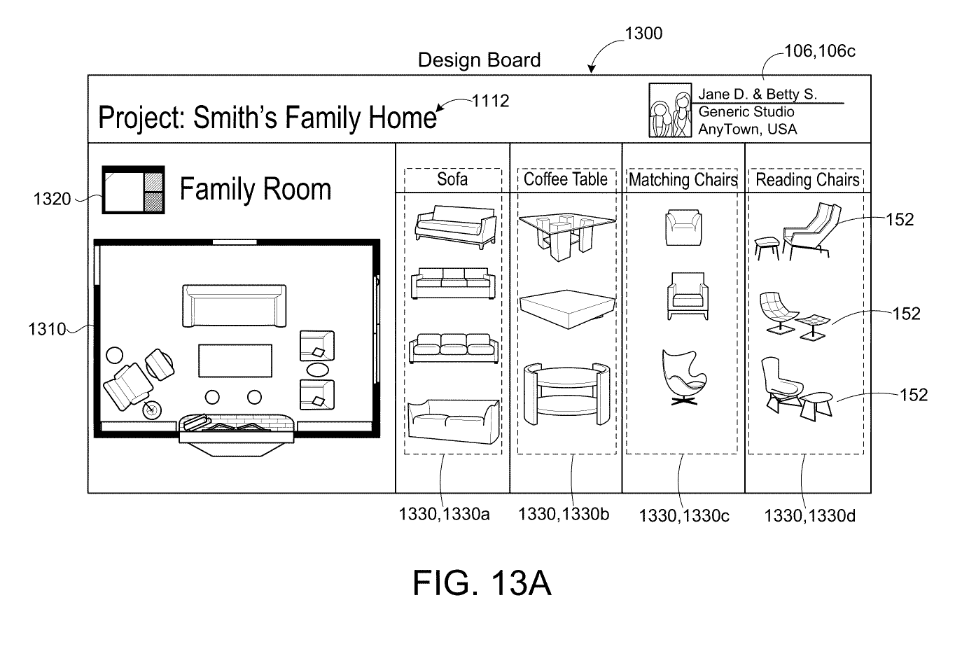

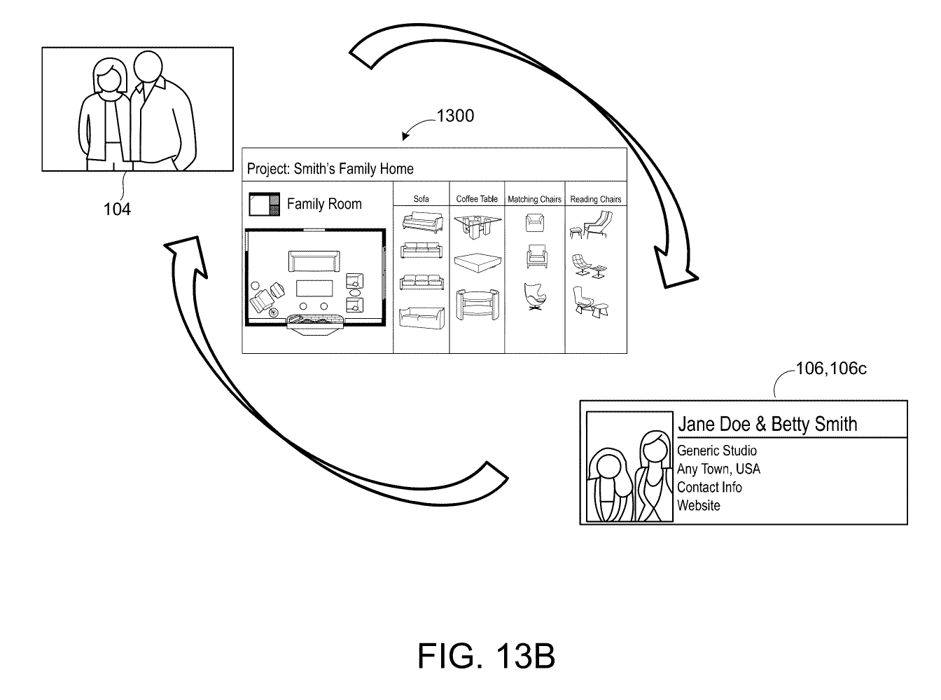

Referring to FIGS. 10, 13A and 13B, in some implementations, the designer 102 and/or the client 104 create a library 7400 of his/her favorite design elements 760 and design looks 750. The library 7400 may include a favorite list 7420 of images 330 of design elements 152 from the system 100. The library 7400 may include a collector image list 1282 of design elements 152 from other websites 1260 collected using the collector button 1205. In some examples, the library 7400 includes an uploaded list 7410 of images 330 captured by the designer 102 and/or the client 104 and uploaded to the system 100. In some examples, the library 7400 includes documents 7440 uploaded or saved electronically by the designer 104. The documents 7440 may include price quotes for design elements 152, communication between the client 102 and the designer 104, images of the space that the designer 102 is designing for the client 104. Additionally or alternatively, both the client 104 and the designer 102 can upload and/or save documents to the library 7400. The documents 7440 may be, but are not limited to the following types, a word file, a three-dimensional snapshot of a design, an Excel Sheet, a JPEG file, an MPEG file). The client 104 and/or the designer 102 may organize the documents 7440 based on their type (e.g., quotes, samples, list of manufactures, etc.)

In some implementations, the library 7400 maintains all the images 330 of the image lists 1282, 7410, 742.0 indicated as a favorite by the designer 102 and/or the client 104. In some implementations, the library 7400 organizes the images 330 included in the lists 1282, 7410, 7420 based on the design project profile 130. Additionally or alternatively, the system 100 may provide the designer 102 and/or the client 104 with an option to search and/or filter the images 330 in the lists 1282, 7410, 7420 within the library 7400. In some implementation, the designer 102 and/or the client 104 shares his/her favorite design elements 760 and/or images 710 from the look book view 700 with the other. In some examples, the designer 102 and/or the client sees a design element 152 and takes a picture of the design element 152 without knowing the manufacturer of the design element 152. The system 100 may locate the manufacturer of the design element 152 and request a price quote from the manufacturer and provide it to the designer 102 and/or the client. In some implementations, the designer 102 maintains his/her personal library 7400 of design elements 152 and creates a project library 7430 by selecting design elements 1152 from the library 7400. Additionally or alternatively, the designer 102 may use the design elements 152 from the library 7400 to add elements 152 to a design board 1300 or a mood board 1500. In some examples, the designer 102 creates a design board 1300 and shares it with the client 104. The client 104 provides feedback to the designer 102, and the designer 102 makes changes to the design board 1300 and shares it with the client 104. The designer 102 keeps updating the design board 1300 until the client is satisfied with the final result. The designer 102 may request a price quote for any design elements 152 from other websites, and once the client 104 approves the prices, the designer 102 places an order 7460 for the design elements 152.

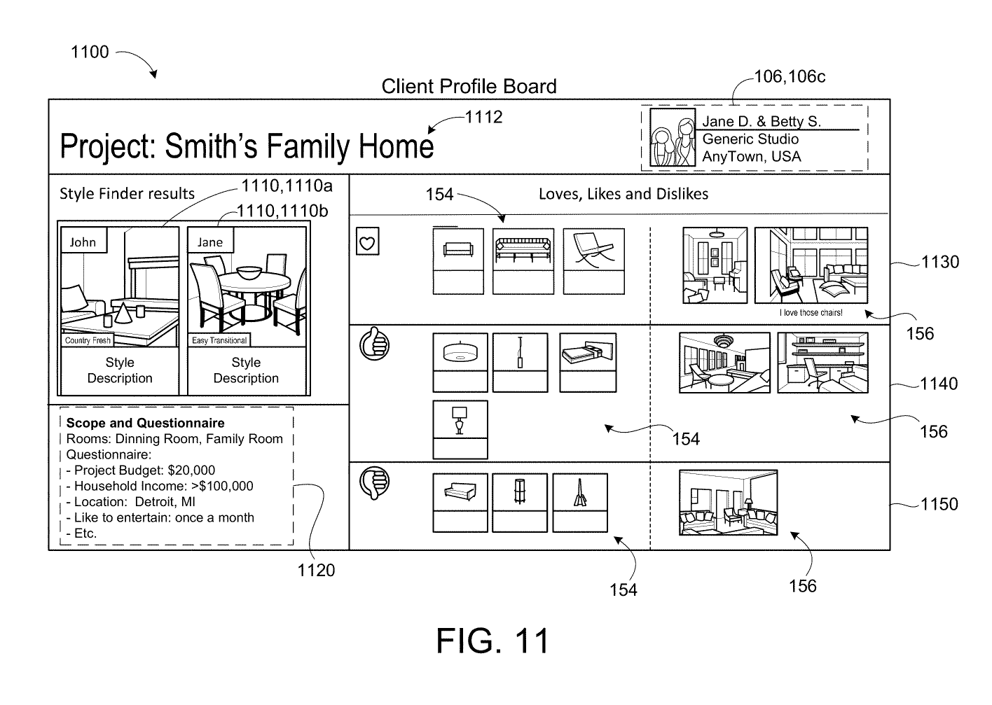

Referring to FIG. 11, in some implementations, the project profile 130 may include one or more project attributes, such as, but not limited to, a project name, target design room(s), a project budget range, maximum and/or minimum project budget thresholds, project style, color theme, current furniture, focal piece, product usage, etc. The design system 100 may acquire the project profile 130 information while acquiring information about the client preferences 120. A client profile board 1100 includes the answers to the questions 320 that the client 104 provided in the previous views including but not limited to a project name 1112, the selected designer information 106c, the image 1110 representing the client style 110, the project budget and other project related information 1120, design images 156 and design elements 154 that have been selected using the favorite button 740, etc. In some examples, the system 100 divides the client profile board 1100 into multiple portions. The top left portion may display the project name 1112, and the top right portion may display the designer 106c (or design company) that the client 104 selected to work on the project. The center left portion may display the images 1110 representing the client style 110. In some examples, the design system 100 displays the images 1110a, 1110b representing two clients 104 who decided to decorate a room together and therefore combine their styles 110. In some examples, the system 100 displays the design elements 154 and the design images 156 that the client loves 1130, likes 1140, or dislikes 1150. Each of these sections 1130, 1140, 1150 may be further divided into the design elements 154 or the styles of the design images 156 that the client 104 loves, like, or dislike.

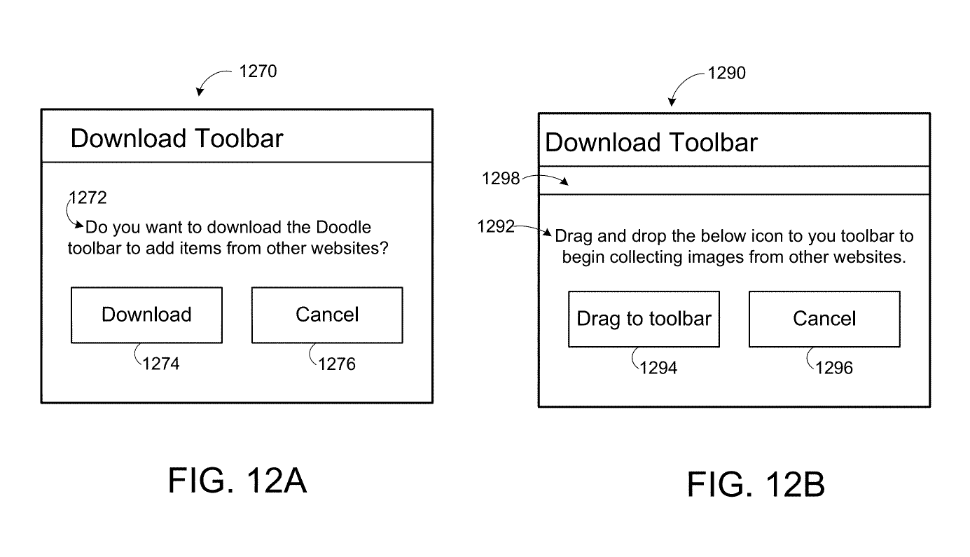

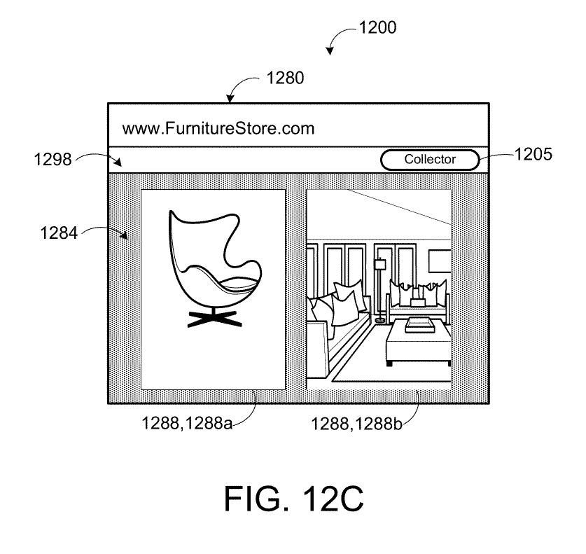

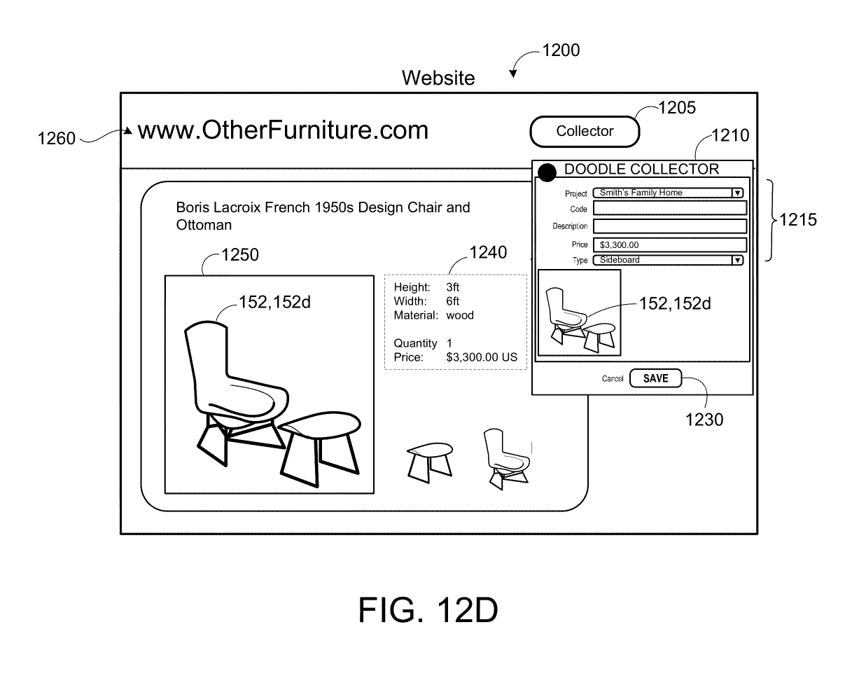

Referring to FIG. 12A-12D, in some implementations, the system 100 provides the designer 102 or the client 104 with the option to download a collector button 1205 to a toolbar 1298 of a web browser 1200. The system 100 may present the designer 102 or the client 104 with a download window 1270 having a question 1272 to confirm if the designer 102 or the client 104 wants to download the collector button 1205 to the toolbar 1298. The designer 102 or the client 104 may either download the collector button 1205 by clicking the download button 1274, or he/she may decide not to download the toolbar and click on the cancel button 1276. When the designer 102 or the client 104 clicks the download button 1274, the system will download the collector button 1205 to the toolbar 1298 of the designer 102 or the client 104.

Referring to FIG. 12B, in some implementations, the system 100 provides the designer 102 or the client 104 with a download window 1290 having a statement 1292 informing the designer 102 or the client 104 that he/she can drag a collector button 1205 to the toolbar 1298. If the designer 102 or the client 104 chooses to add the collector button 1205 to their toolbar 1298, he/she can drag the button 1294 and drop it in his/her toolbar 1298. The designer 102 or the client 104 may not want to add the collector button 1205 to their toolbar and click the cancel button 1296.

Referring to FIG. 12C, in some implementations, the collector button 1205 appears in a toolbar 1206 of the web browser 1200 of every webpage 1280 that the designer 102 or the client 104 visits. The designer 102 or the client 104 may select the collector button 1205 to choose an image 1288 to add it to a client profile board 1100 (FIG. 11). In some examples, when the designer 102 or the client 104 clicks on the collector button 1205, the background 1284 of the webpage 1280 fades and the images 1282 that may be collected are highlighted. The designer 102 or the client 104 may then choose the image 1288 that he/she wants to collect.

Referring to FIG. 12D, in some implementations, the client 104 or the designer 102 collects an image 1282 of a design element 152 from other websites 1260 and adds the collected image 1282 of the element 152d or design inspiration to his/her design board 1300. The other website 1260 may have a photograph 1250 and information 1240 of the design element 152d. When the client 104 collects the image 150 of the design element 152, some of the information of the design element 152 may be prepopulated in the information 1215 section of the collector view 1210. In some examples, the client 104 may add or change the information 1215 relating to the design element 152d. In some examples, when the client 104 selects the save button 1230, the system 100 adds the collected design elements 152d to the client profile board 1100. The client 104 may use the client profile board 1100 to purchase the design element 152d he/she collected from a different website 1260. The system 100 may go to the specific website 1260 and order the design element 152d and send it to the client 104 based on the ordering information that client 104 provides.

Referring to FIGS. 13A and 13B, in some implementations, a design board 1300 provides the client 104 and the designer 102 with an overview of the floor plan 1310, the color palette 1320, and the design elements 152 (e.g., furniture pieces) the client 104 and the designer 102 are considering for the room. In some examples, the client 104 and the designer 102 collaborate and both add design elements 152 to the design board 1300. The design board 1300 may display the project name 1112 in a consistent location with the view 1100 from FIG. 11, which also includes the designers 106c that the client 104 chose to work on the project. In some implementations, the left portion of the view is a floor plan 1310 of the room which the client 104 wants to design. The floor plan 1310 is not an accurate representation of the room dimensions, but the measurements are proportional to the actual room. Therefore, the floor plan 1310 provides an accurate representation of the dimensions of the room with the furniture placement. In some implementation, a three dimensional view of the room is displayed and allows the client to view different perspectives of the room. The user may choose a color palette 1320, and the system 100 may display the color palette 1320 above the floor plan 1310. The color palette 1320 may include one or more colors. The right portion of the view may be divided into furniture groupings 1330, each group 1330 including potential design elements 152 that the client 104 may consider for the design. In some examples, where the client 104 is decorating his/her family room, these items may include sofas 1330a, coffee tables 1330b, matching chairs 1330c, reading chairs 1330d, lamps, rugs, wall decorations, wall paper, accessories, etc. These items may be listed horizontally. Additionally or alternatively, the designer 102 may customize the design board view 1300 by arranging the different portions of the client profile view 1100 and hide or display specific portions. For example, the designer 102 may decide that the color palette 1320 should not be displayed on the design board 1300 and therefore may remove it from the view 1300. In some examples, the designer 102 may rearrange the portions of the view (e.g., the designer 102 may decide to display the floor plan 1310 on the right portion of the view 1300). Referring to FIG. 13B, the designer 102 and/or the client 104 may add furniture to each list for further consideration by the other. The designer 102 and/or the client 104 may delete design elements 152 from the groupings 1330 displayed in the design board 1300. In some examples, only the designer 102 can manipulate and change the layout or delete and add items to the design board 1300. The client 104 provides the designer 102 with his/her feedback and the designer 102 updates the design board 1300 based on the feedback provided.

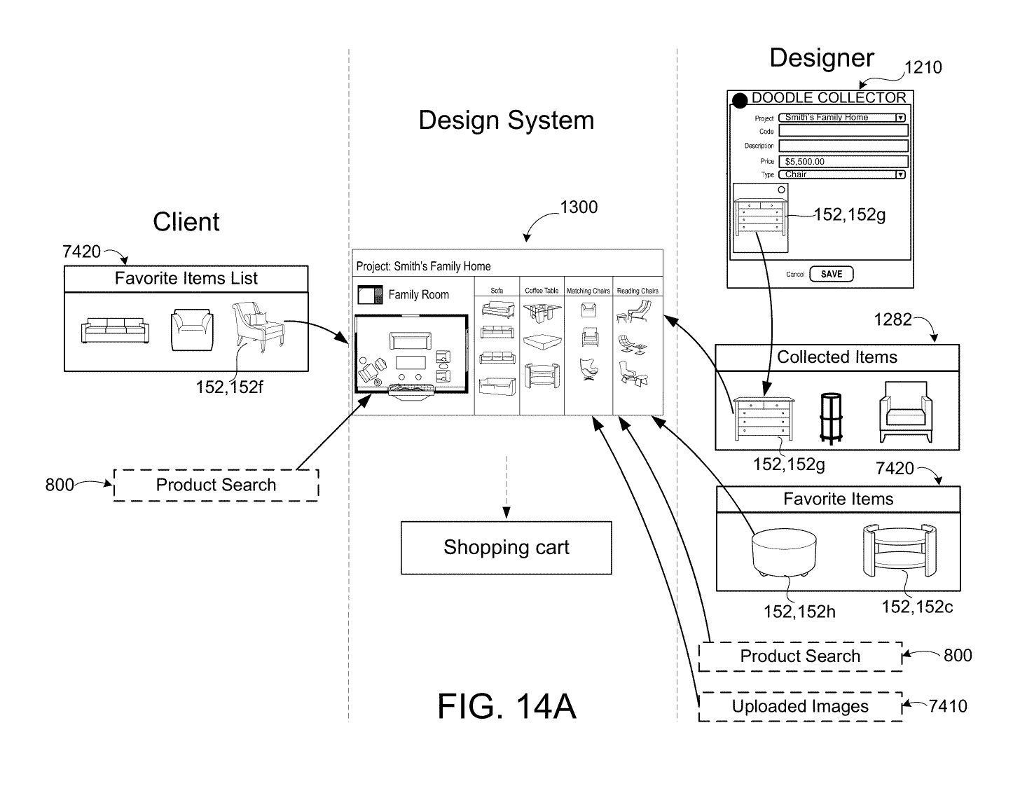

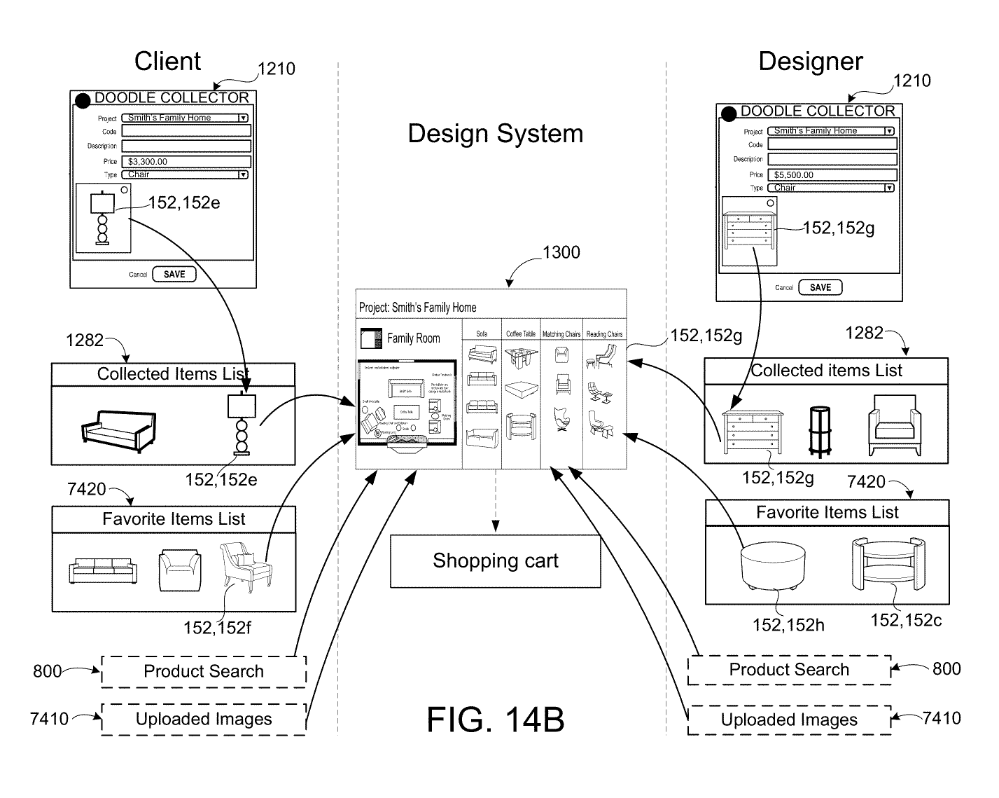

Referring to FIG. 14A, in some implementations, the designer 102 can collect design elements 152, 152g from different websites. The designer 102 may add the collected design element 152g to the design board 1300 and the client 104 can provide feedback to the designer 102 about the design elements 152 on the design board 1300. The designer 102 may add design elements 152 from the library 7400 which includes a list 1282 of design elements 152 collected from other websites 1260, favorite design elements 760 from the favorite image list 7420, images 330 from the uploaded images list 7410, or from a product search view 800. Additionally or alternatively, the client 104 may add design elements 152, 152f from his/her favorite list 770, or from a product search view 800. The system 100 gives the designer 102 control over the design board 1300 allowing the client 104 to give feedback and the designer 102 to design with consideration of the input from the client 104.

Referring to FIG. 14B, in some implementations, the system 100 allows each of the designer 102 and/or the client 104 to collect design elements 152, 152e, 152g from different websites. Each of the designer 102 and the client 104 may add the collected design element 152, 152e, 152g to the design board 1300. In some examples, the designer 102 and the client 104 may add design elements 152, 152f, 152h from their respective favorite item list to the design board 1300. The interaction between the client 104 and the designer 102 facilitates the design process for the client 104. Such interaction includes feedback from the client 104 to the designer 102 and vice versa. In some examples, the client 104 selects a design element 152e he/she wants to buy from the mood board 1500 and proceeds to purchase the element 152e. Therefore, the system 100 allows the client 104 to purchase design elements 152 available through the design system 100, or design elements 152 that the client 104 found on other websites 1260. The design system 100 facilitates the purchasing experience for the client 104 because the client 104 can use the system 100 to decorate his entire house and order different design elements 152 from different locations using the system 100. Additionally or alternatively, the designer 102 or the client 104 may decide to look for other design elements 152 to match the pieces already on the mood board view 1500. The designer 102 or the client 104 may add design elements 152 from the product search view 800 and add these elements directly to the mood board view 1500.

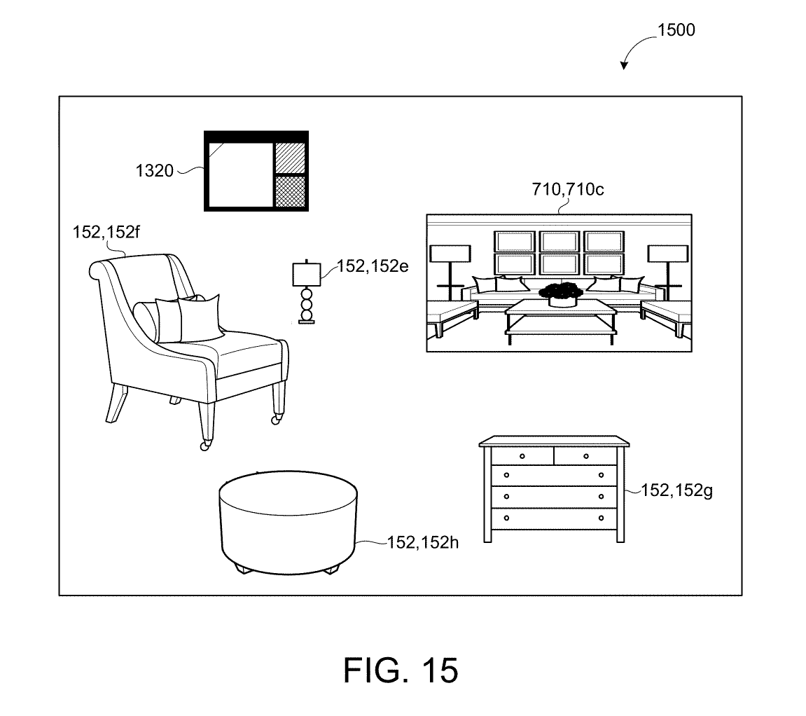

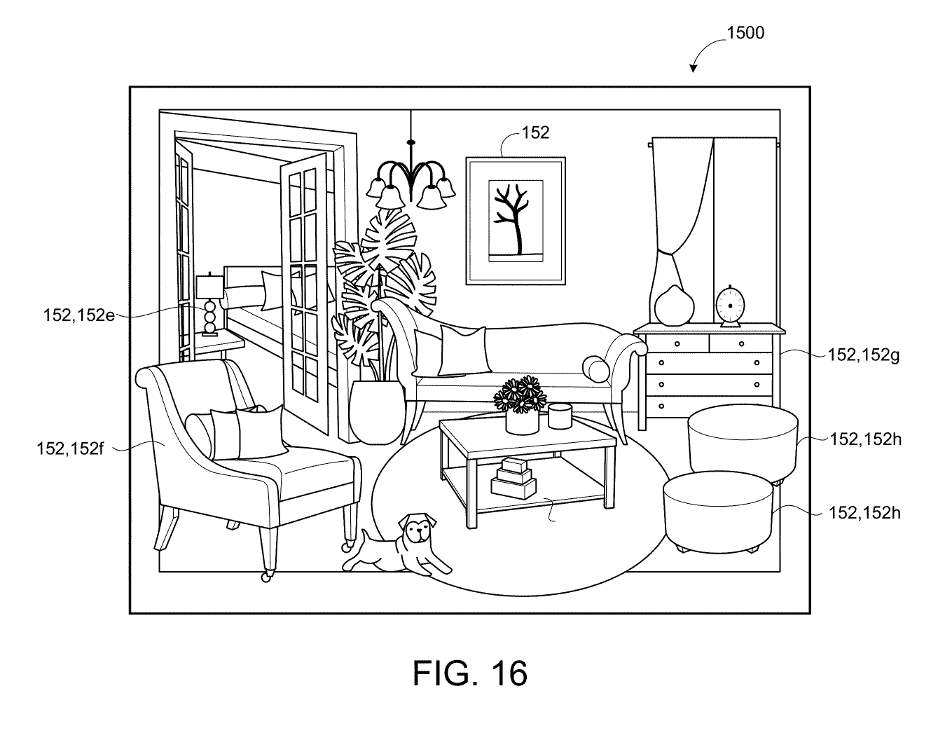

Referring to FIGS. 15 and 16, in some implementations, the system 100 has a mood board view 1500. The mood board 1500 allows the designer 102 and/or the client 104 to interactively place the design elements 152 (e.g., lamps 152e, chairs 152f, dresser 152g, and ottoman 152h) on the mood board 1500. The mood board 1500 gives the designer 102 and/or client 104 a better visualization of how the design elements 152 will look next to each other. The designer 102 and/or the client 104 may interactively relocate the design elements 152 and share the proposed mood board view 1500 with one another. The mood board 1500 may provide the designer 102 and/or the client 104 the option to manipulate the design elements 152 by moving each element 152 either backwards with respect to another element 152, or forward with respect to another element 152. The manipulation of design elements 152 from front to back or back to front allows the client 104 to better visualize the finalized design. Other ways to manipulate a design element 152 may include, but are not limited to, cropping, rotating, resizing, and changing the color. In some examples, the designer 102 or client 104 takes a snapshot of the mood board 1500 and saves it. The saved snap shot of the mood board 1500 may later be compared with another saved snap shot of another mood board 1500 so that the client 104 compares the two proposals of design. In some implementations, the mood board 1500 is a three dimensional board and the designer 102 or the client 104 may place the design elements 152, also represented in a three dimensional image, on the three dimensional board. The designer 102 or the client 104 may rotate the three dimensional board to view the room from different angles. The mood board 1500 may include design elements saved as favorites (e.g., 152e, 152f, 152g, and 152h), the color palette 1320, and a favorite image 710c from the took book view 700.

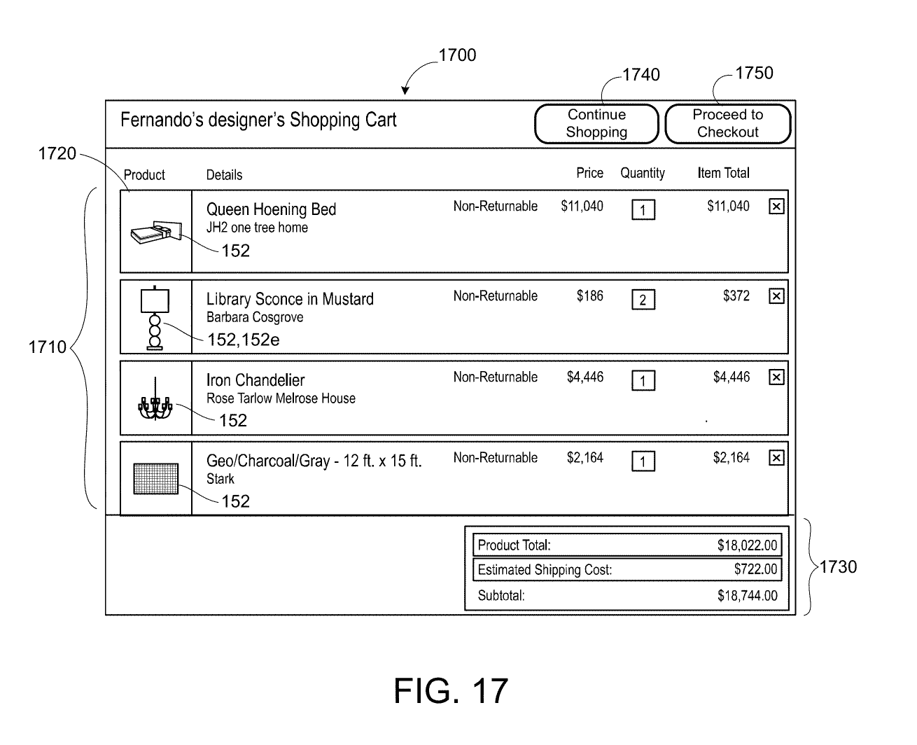

Referring to FIGS. 17-19, in some implementations, the client 104 views a list 1710 of the design elements he/she decided to purchase in his/her shopping cart view 1700. The list 1710 may include design elements 152 chosen from the current website, or design elements 152e collected from other websites 1260. The list 1710 may display a picture 1720 of the design elements 152 being purchased, a description of the item, the dimensions of the item, the price, the quantity, the color, the price based on the quantity, and finally total price 1730 of the item. The shopping cart view 1700 may also direct the client to either continue shopping 1740 or proceed to checkout 1750 where he/she will be prompted to make the payment and specify where the items should be shipped to.

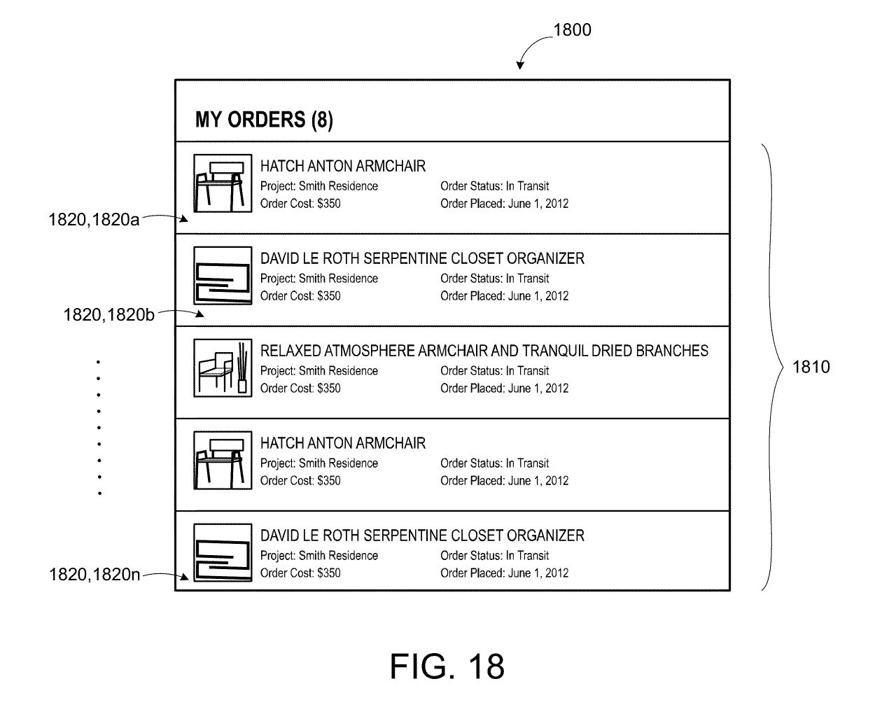

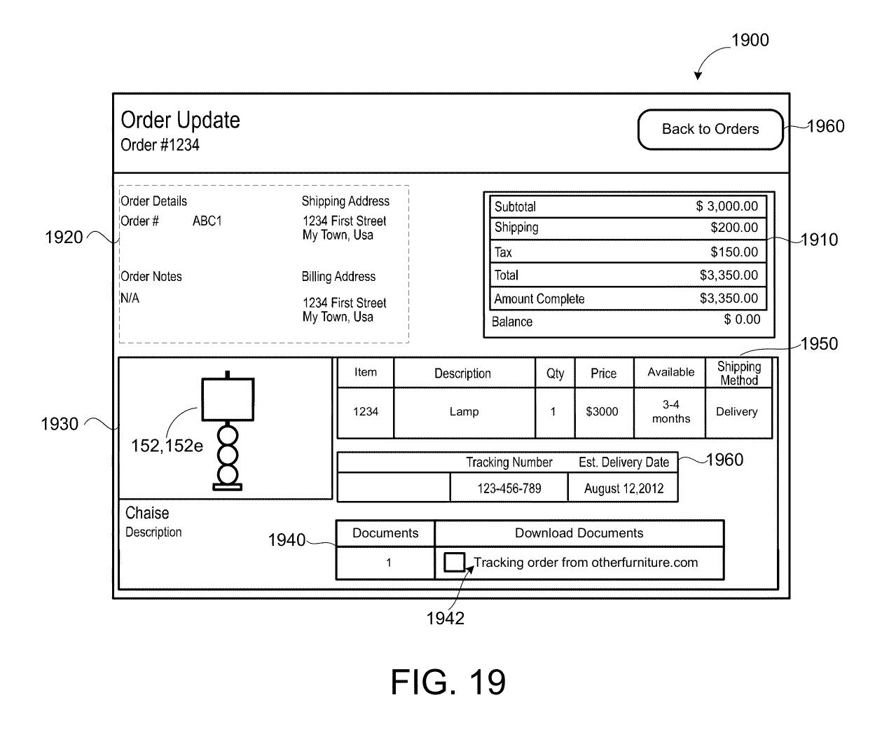

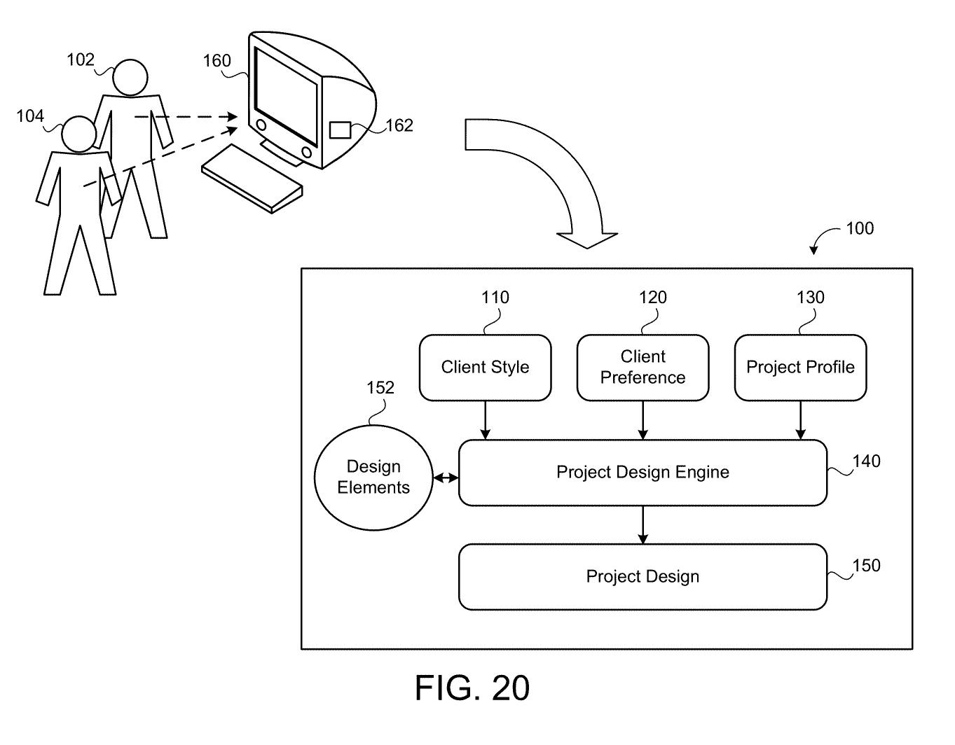

Referring to FIGS. 18 and 19, in some implementations, the client 104 views the orders 1820 he/she placed. The client 104 may track the order information for orders placed from the website or from different websites. The order view 1800 displays a list 1810 of the items that the client 104 has ordered. The client 104 may decide he/she wants more information regarding the order and may select a specific order 1820a, FIG. 20 provides a detailed view 1900 of one of the orders selected from the order view 1800. The detailed order view 1900 may include the price of the item and the total amount 1910 that the client 104 paid and what he/she still owes, a detailed description 1920 of the order, an enlarged photograph 1930 of the item ordered 152e, the item number/description/price 1950, and information 1960 relating to a tracking number and the estimated time of delivery. In some examples, the detailed order view 1900 may include a design element 152e which the client 104 ordered from a different website 1260. The system 100 provides the order information of these orders via a document 1942 that the user can download from the system 100. The system 100 displays a download view 1940 to inform the client 104 that the document 1942 is ready for downloading. The download view 1940 may display more than one document 1942 if the client 104 placed more than one order with another website 1260. Additionally or alternatively, the system 100 sends an email to the designer 102 and/or the client 104 to inform him/her of an updated status of the order. The system 100 may send an email to the designer 102 and/or the client 104 including the downloadable document 1942 as an attachment, a link to the downloadable document 1942, or a notice that the downloadable document 1942 is available, therefore allowing the designer 102 and the client 104 to download the file from the system website or from their email and confirm the details of the order. In some implementations, the system 100 only allows the designer 102 to place the orders for the design elements 152 after approval from the client 104.

In some implementation, when the designer 102 and/or the client 104 want to purchase a design element 152 from another website 1260, the system 100 requests a price quote from the other website 1260 for corresponding manufacturer/provider of the design element 152). When the quote is received, the system 100 notifies the designer 102 and/or client 104 by sending them an email with a notification of the order status (e.g., a notification of the received quote fir review). The system 100 may attach a file containing the quote to the email. In some examples, the system 100 sends the designer 102 and/or the client 104 a request for authorization to purchase the design element 152 from the other website 1260. When the designer 102 and/or the client 104 approves the order, the system 100 proceeds with sending an order request to the manufacturer/provider of the design element 152 located on the other website 1260. In situations where the other website 1260 sends any documentation or files relating to the purchase order, the system notifies the designer 102 and/or the client 104 by email and/or by updating the order status on an order view 1800.

Referring to FIG. 20, in some implementations, an interior design system 100 includes a client style 110, a client preference 120, and a project profile 130, each of which may be a programmatic object (e.g., java script object notation (JSON) object, persistent object, or other object) stored in memory (e.g., in a database or random access memory (RAM)) of a computing device 160. Moreover, each object may have one or more associated attributes or properties. The interior design system 100 chooses a client style 110 for the client 104 based on a series of questions the client 104 answers. The project profile 130 provides an overview of the project attributes and includes attributes such as the project name, the design room(s), the project budget, etc. The system 100 considers the client style 110, the client preferences 120 (e.g., client age, budget, income), and the project profile 130 to choose a project design 150 for the client 104. In some examples, the system 100 considers the input from a human designer 102.

A project design engine 140 communicates with or receives information from the client style 110, the client preference 120, and/or the project profile 130. The project design engine 140 may receive information from the designer 102 to improve the client experience using the interior design system 100. Based on the received information, the project design engine 140 provides a project design 150 (or at least a portion thereof) for implementation by the designer 102 and/or a client 104. The project design engine 140 helps the client 104 choose furnishings that work well with each other as well as match design objectives of the project design 150. The project design engine 140 provides the client 104 with design elements 1152 (e.g., pieces of furniture, colors, color schemes, wall decor, window treatments, floor covers, such as carpets and rugs) similar to his/her style 110.

The client style 110 may include one or more styles 7110 (e.g., single styles or combinations of styles) selected from a list styles. The styles 7110 may include, for example, contemporary, traditional, Asian, classical, arts & crafts, country, art deco, gothic, tropical, rustic, Tuscan, Swedish (Gustavian), Southwestern, minimalist, cool minimalism 7110a, country fresh 7110b, easy transitional 711c, edgy glam, effortless eclectic, industrial chic, not your mother's traditional, and warm contemporary 7110d. Other styles are possible as well.

The project design 150 may be determined by the project design engine 140 using an algorithm or search heuristic (e.g., based on probable selections of design elements). For example, the project design engine 140 may execute a search heuristic on a collection of possible combinations of design elements 152 and selects a combination of design elements 152 based on a probability of combination thereof using the client style 110, the client preference 120, and the design project profile 130. The design elements 152 may include pieces of furniture, colors, color schemes, wall decor, window treatments, floor covers, such as carpets and rugs. The probability of combinations of design elements 152, in some implementations, is based on client-designer interactions (e.g., logged or saved in memory or a database) and/or the browsing history of the client 104 of design elements 152 of a design element collection (e.g., a website, catalog, showroom, etc.).

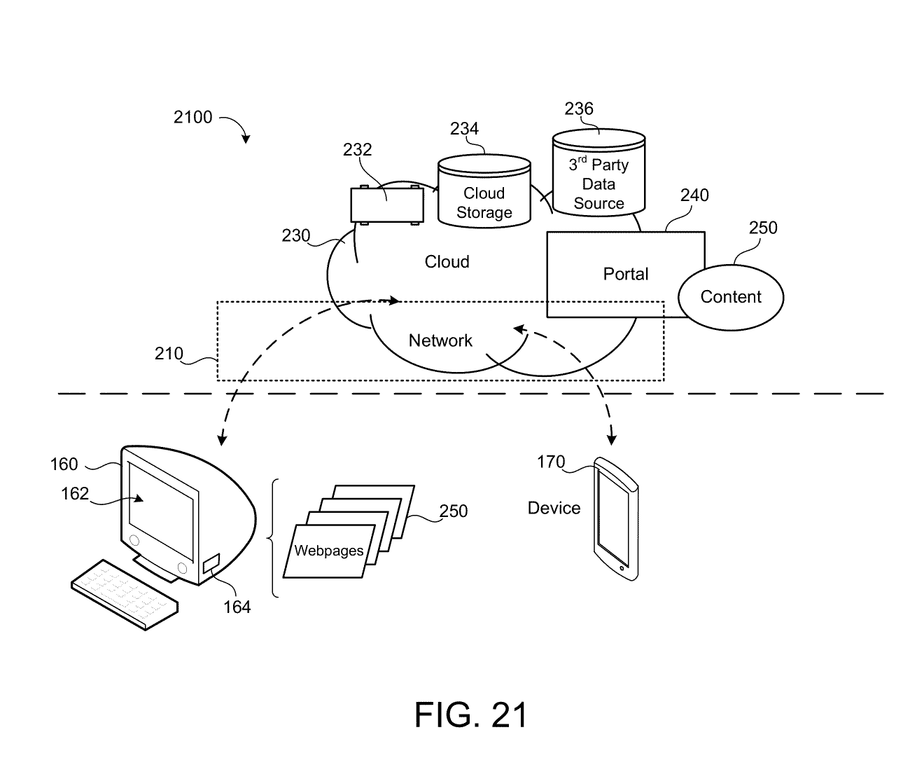

Referring to FIG. 21, in some implementations, an exemplary interior design system 2100 includes a portable electronic device 170 (e.g., personal digital assistant, smartphone, tablet computer, ultra-mobile PC) communicating (e.g., wirelessly or via a wired connection, such as Ethernet or USB) to a communication network 210 and/or a remote computing device 160. The communication network 210 may include a cloud computing service 230 (also referred to as a cloud) having a cloud server 232 and cloud storage 234 in communication with a portal 240 (e.g., web portal) for receiving/transmitting content 250.

Cloud computing may provide Internet-based computing, whereby shared servers provide resources, software, and data to computers and other devices on demand. For example, the cloud 230 may be a cloud computing service that includes at least one server computing device, which may include a service abstraction layer and a hypertext transfer protocol wrapper over a server virtual machine instantiated thereon. The server computing device may be configured to parse HTTP requests and send HTTP responses. Cloud computing may be a technology that uses the Internet and central remote servers to maintain data and applications. Cloud computing can allow users to access and use applications without installation and access personal files at any computer with internet access. Cloud computing allows for relatively more efficient computing by centralizing storage, memory, processing and bandwidth. The cloud 230 can provide scalable, on-demand computing power, storage, and bandwidth. The cloud storage 234 can be a model of networked computer data storage where data is stored on multiple virtual servers, generally hosted by third parties.

The portal 240 may be a web-based user portal for gathering and/or providing information, such as the client style 110, the client preference 120, and the design project profile 130, etc. Information can be integrated with third-party information to provide additional functionality and resources to the user. In some examples, the portal 240 is a personal portal web site on the World Wide Web. The portal 240 may provide personalized capabilities and a pathway to other content. The portal 240 may use distributed applications, different numbers and types of middleware and hardware, to provide services from a number of different sources. In addition, business portals 240 may share collaboration workplaces and provide content 250 usable on multiple platforms such as personal computers, personal digital assistants (PDAs), and cell phones/mobile phones. Information, news, and updates are examples of content 250 that may be delivered through the portal 240.

The content 250 may include any digital content associated with or executable on the portable electronic device 170. Examples, include, but are not limited to, the client style 110, the client preference 120, and the design project profile 130, etc.

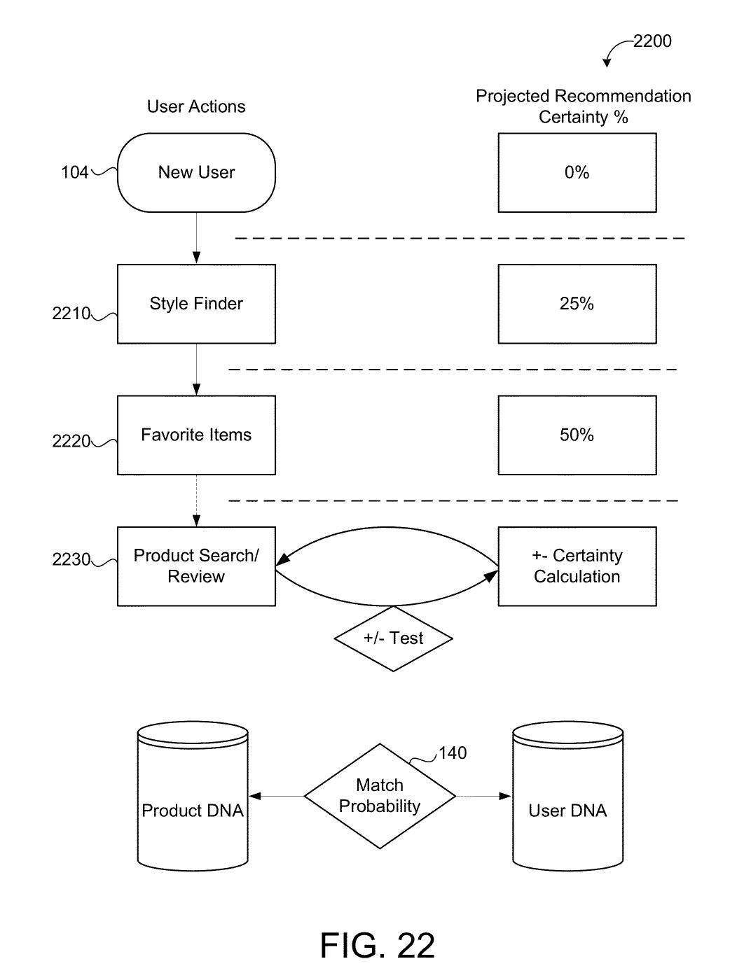

Referring to FIG. 22, in some implementations, a schematic view of an exemplary interior design system 2200 where a client 104 uses a style finder 2210 to determine the client style 110 and a preference finder 2220 to determine the client preference 120. The system 2200 may also include a product search/review module 2230 that allows viewing of design elements 152 to determine a probability of selection by the client 104 and a probability of combination with other design elements 152 to form the project design 150.

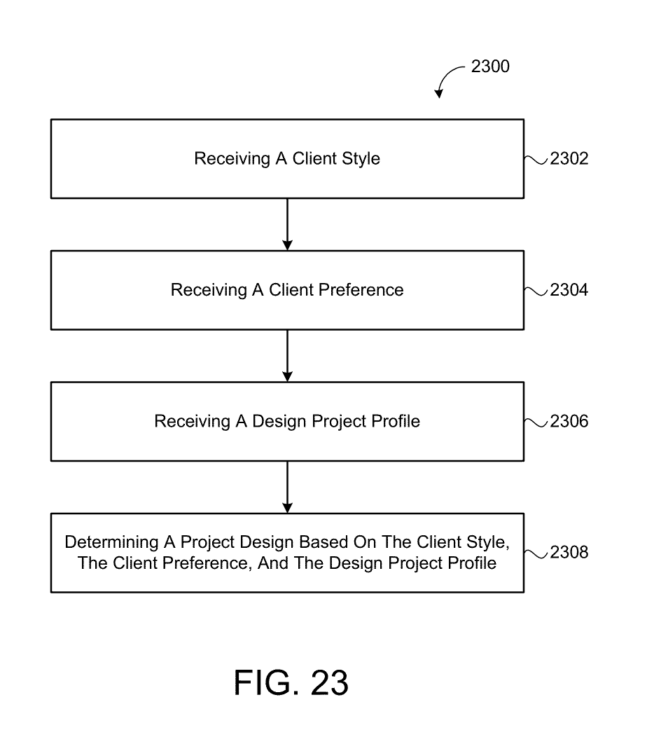

FIG. 23 provides an exemplary arrangement 2100 of operations for a method 2100 of interior design. The method includes receiving 2302 a client style 110, receiving 2304 a client preference, receiving 2306 a design project profile 130, and executing 2308 a routine on a computing processor 164 of the computing device 160 (or other computing processor, such as a cloud computing processor) to determine 308 a project design based on the client style 110, the client preference, and the design project profile 130 (e.g., by executing a routine on a computing processor 160, 164.

In some implementations, the client style 110 includes a programmatic object stored in memory and having one or more properties. The client style 110 may include at least one of contemporary, traditional, Asian, classical, arts & crafts, country, art deco, gothic, tropical, rustic, Tuscan, Swedish, Southwestern, or minimalist, cool minimalism 7110a, country fresh 7110b, easy transitional 7110c, edgy glam, effortless eclectic, industrial chic, not your mother's traditional, and warm contemporary 7110d, which may be stored as a property. Other styles 7110 are possible as well.

In some examples, the method includes displaying a series of design elements 152 (e.g., photographs of design elements or combinations thereof), receiving a user style input (see e.g., FIG. 3A, a selected image 330) with respect to each design element 152, and determining the client style 110 based on the user style inputs. The method may include receiving a client ranking of each design element 152 and determining the client style 110 based a weighted average of the ranked design elements 152.

The client preference 120 may be a programmatic object stored in memory and having one or more properties. In some examples, the client preference 120 includes at least one of a weighted list of client styles, a budget range, a maximum budget threshold, a minimum budget thresholds, a client income, a client family status, a client family size, a number of viewings of one or more pieces of furniture, or a browsing history of pieces of furniture, which may be stored as a property.

In some implementations, the method includes executing a search heuristic on a collection of possible combinations of design elements 152 and selecting 1452 a combination of design elements 152 based on a probability of combination using the client style 110, the client preference 120, and the project profile 130. The method may also include selecting the combination of design elements 152 based on client-designer interactions and/or a browsing history of design elements 152. The design elements 152 may include at least one of a piece of furniture, a color, a color scheme, wall decor, a window treatment, or a floor covering.

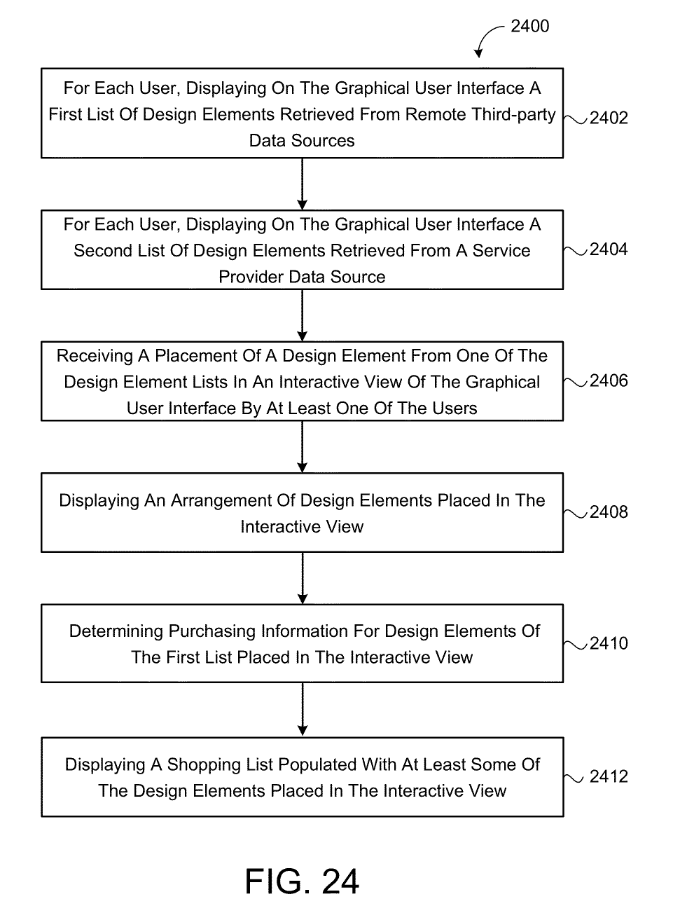

FIG. 24 provides an exemplary arrangement 2400 of operations for a method 2400 of collaborative interior design between users (e.g., a designer 102 and a client 104) on a displayed graphical user interface 162. The method includes for each user, displaying 2402 on the graphical user interface 162 a first list 1282 of design elements 152 retrieved from remote third-party data sources 236 and displaying 2404 on the graphical user interface 162 a second list 7420 of design elements 152 retrieved from a service provider data source 234. The method further includes receiving 2406 a placement of a design element 152 from one of the design element lists 1282, 7420 in an interactive view 1300, 1500 of the graphical user interface 162 by at least one of the users 102, 104, and displaying 2408 an arrangement of design elements 152 placed in the interactive view 1300, 1500. The method includes executing on a computing processor 160, 164 an information acquisition routine that determines 2410 purchasing information 1900 for design elements 152 of the first list 1282 placed in the interactive view 1300, and displaying 2412 a shopping list 1710 populated with at least some of the design elements 152 placed in the interactive view 1300, 1500.

In some examples, the method further includes displaying on the graphical user interface 162 a series of images 330, then receiving a user style input with respect to each image 330, and determining the user style 110 based on the user style inputs. The method may include displaying a third list 860 of design elements 152, each having a style matching the received at least one style of the corresponding user 102, 104.

In some examples, the method 2300 includes receiving a design project profile 130 (e.g., a project name, target design room(s), a project budget range, maximum and/or minimum project budget thresholds, project style, color theme, current furniture, focal piece, product usage, etc.), receiving at least one preference 120 associated with each user, and determining the second list of design elements based on the style 110 associated with each user, the user preference 120, and the project profile 130. The method 2300 may execute a search heuristic on a collection of possible combinations of design elements 152 and select a combination of design elements 152 based on a probability of combination using at least one style associated with each user, at least one preference 120 associated with each user, and the design project profile 130.

Additionally or alternatively, displaying the second list of design elements may include for each user, retrieving design elements identified as liked-elements from the service provider data source 234. Displaying the first list 1282 of design elements 152 may include for each user 102, 104, retrieving design elements 152 identified as liked-elements 760 from the third-party service provider 236. In some examples, the method 2300 further includes receiving information from the remote third-party data sources 236 regarding at least one of a price, a color, a color pallet, or dimensions. Displaying the shopping list 1710 may include acquiring purchasing information 1900 from the remote third-party data source 236; and displaying on the graphical user interface an option to view the acquired purchasing information.

In some implementations, the method 2300 includes taking a still image of the interactive view 1300, 1500. The method may include identifying a design element and moving the design element 152 forward or backward with respect to another design element 152 and/or rotating the design element 152.

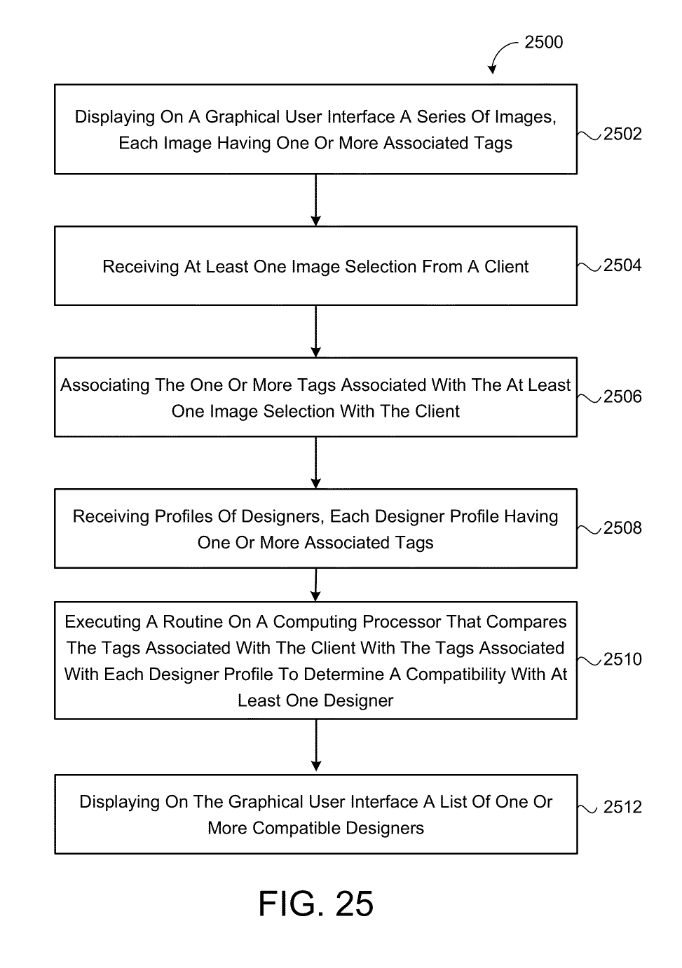

FIG. 25 provides an exemplary arrangement 2500 of operations for a method 2500 of matching a client 104 and a designer 102 for collaborative interior design. The method 2500 includes displaying 2502 on a graphical user interface 162 (FIG. 21) a series of images 330, each image having one or more associated tags 332. The method also includes receiving 2504 at least one image selection from a client 104, associating 2506 the one or more tags 332 associated with the at least one image selection with the client 104, and receiving 2508 profiles 102a-n of designers 102, each designer profile 122a-n having one or more associated tags 332. The method further includes executing 2510 a routine on a computing processor 160, 164 that compares the tags 332 associated with the client 104 with the tags 332 associated with each designer profile 122a-n to determine a compatibility with at least one designer 102, and displaying 2512 on the graphical user interface 162 a list 1000 of one or more compatible designers 102.

In some examples, the routine determines the compatibility between the client 104 and the designers 102 based on a number of common tags 332 associated with the client 104 and the profiles of the designers 102.

In some examples, the method includes executing a routine on a computing processor 160, 164 that determines a client style 110 based on the tags 332 associated with the client 104. The method may further includes displaying on the graphical user interface 162 a first list of design elements 152 retrieved from remote third-party data sources 236, a second list of design elements 152 retrieved from a data source 234 of a service provider 230, and receiving a placement of a design element 152 from one of the design element lists in an interactive view of the graphical user interface 162 by the designer 102. The method may include displaying an arrangement of design elements 152 placed in the interactive view 1300, 1500, executing on a computing processor 160, 164 an information acquisition routine that determines purchasing information 1900 for design elements 152 of the first list placed in the interactive view, and displaying a shopping list 1710 populated with at least some of the design elements 152 placed in the interactive view 1300, 1500. In some examples, the method includes displaying on the graphical user interface 162 a third list 860 of design elements, each having a style matching the client style 110. The method may include receiving images 330 captured by the designer 102 and displaying a fourth list 7410 of design elements 152, the list 7410 comprising the received uploaded images 330. In some examples, displaying the first or second list 1282, 7420 of design elements 152 comprises design elements 152 identified as liked-elements 760 by the client 104.

In some examples, the method further includes receiving information from the remote third-party data sources 236 regarding at least one of a price, a color, a color pallet, or dimensions. Displaying the shopping list 1710 may include acquiring purchasing information 1900 from the remote third-party data source 236, and displaying on the graphical user interface 162 an option to view the acquired purchasing information 1900. In some examples, the method further includes capturing an image of the interactive view 1300, 1500.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language, As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular implementations of the invention. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method of collaborative interior design between users on a displayed graphical user interface, the method comprising:
for each user, displaying on the graphical user interface:
a first list of design elements retrieved from remote third-party data sources; and
a second list of design elements retrieved from a data source of a service provider;
receiving a placement of a design element from one of the design element lists in an interactive view of the graphical user interface by at least one of the users;
displaying an arrangement of design elements placed in the interactive view;
executing on a computing processor an information acquisition routine that determines purchasing information for design elements of the first list placed in the interactive view; and
displaying a shopping list populated with at least some of the design elements placed in the interactive view.

2. The method of claim 1, further comprising:
displaying on the graphical user interface a series of images;
receiving a user style input with respect to each image; and
determining the user style based on the user style inputs.

3. The method of claim 2, further comprising for each user, displaying a third list of design elements, each having a style matching the received at least one style of the corresponding user.

4. The method of claim 3, further comprising:
receiving a design project profile;
receiving at least one preference associated with each user; and
determining the second list of design elements based on the style associated with each user, the user preference, and the project profile.

5. The method of claim 1, further comprising executing a search heuristic on a collection of possible combinations of design elements and selecting a combination of design elements based on a probability of combination using at least one style associated with each user, at least one preference associated with each user, and the design project profile.

6. The method of claim 1, wherein displaying the second list of design elements comprises for each user, retrieving design elements identified as liked-elements from the service provider.

7. The method of claim 1, wherein displaying the first list of design elements comprises for each user, retrieving design elements identified as liked-elements from the third-party data sources.

8. The method of claim 7, further comprising receiving information from the remote third-party data sources regarding at least one of a price, a color, a color pallet, or dimensions.

9. The method of claim 1, wherein displaying the shopping list comprises:
acquiring purchasing information from the remote third-party data source; and
displaying on the graphical user interface an option to view the acquired purchasing information.

10. The method of claim 1, further comprising capturing an image of the interactive view.

11. The method of claim 1, further comprising identifying a design element and moving the design element forward or backward with respect to another design element.

12. A computer program product encoded on a non-transitory computer readable storage medium comprising instructions that when executed by a data processing apparatus cause the data processing apparatus to perform operations allowing collaboration between two users on a graphical user interface, the operations comprising:
for each user, displaying on the graphical user interface:
a first list of design elements retrieved from remote third-party data sources; and
a second list of design elements retrieved from a data source of a service provider;
receiving a placement of a design element from one of the design element lists in an interactive view of the graphical user interface by at least one of the users;
displaying an arrangement of design elements placed in the interactive view;
executing on a computing processor an information acquisition routine that determines purchasing information for design elements of the first list placed in the interactive view; and
displaying a shopping list populated with at least some of the design elements placed in the interactive view.

13. The computer program product of claim 12, wherein the operations further comprise:
displaying on the graphical user interface a series of images;
receiving a user style input with respect to each image, and
determining the user style based on the user style inputs.

14. The computer program product of claim 13, wherein the operations further comprise fur each user, displaying a third list of design elements, each having a style matching the received at least one style of the corresponding user.

15. The computer program product of claim 14, wherein the operations further comprise:
receiving a design project profile;
receiving at least one preference associated with each user; and
determining the second list of design elements based on the style associated with each user, the user preference, and the project profile.

16. The computer program product of claim 14, wherein the operations further comprise executing a search heuristic on a collection of possible combinations of design elements and selecting a combination of design elements based on a probability of combination using at least one style associated with each user, at least one preference associated with each user, and the design project profile.

17. The computer program product of claim 12, wherein displaying the second list of design elements comprises for each user, retrieving design elements identified as liked-elements from the service provider.

18. The computer program product of claim 12, wherein displaying the first list of design elements comprises for each user, retrieving design elements identified as liked-elements from the third-party data sources.

19. The computer program product of claim 18, wherein the operations further comprise receiving information from the remote third-party data sources regarding at least one of a price, a color, a color pallet, or dimensions.

20. The computer program product of claim 12, wherein displaying the shopping list comprises:
acquiring purchasing information from the remote third-party data source; and
displaying on the graphical user interface an option to view the acquired purchasing information.

21. The computer program product of claim 12, wherein the operations further comprise capturing an image of the interactive view.

22. The computer program product of claim 12, wherein the operations further comprise identifying a design element and moving the design element forward or backward with respect to another design element.

23. An interior design system comprising:
a client style;
a client preference;
a project profile; and
a project design engine executing on a computing processor and in communication with the client style, the client preference, and the project profile, the project design engine determining a project design based on the client style, the client preference, und the design project profile;
wherein the project design engine executes a search heuristic on a collection of possible combinations of design elements and selects a combination of design elements based on a probability of combination using the client style, the client preference, and the design project profile.

24. The interior design system of claim 23, wherein at least one of the client style, the client preference, or the project profile comprises a programmatic object stored non-transitory memory and having one or more properties.

25. The interior design system of claim 23, wherein the client style comprises a weighted average of ranked images.

26. The interior design system of claim 23, wherein the client preference comprises at least one of a weighted list of client styles, a budget range, a maximum budget threshold, a minimum budget thresholds, a client income, a client family status, a client family size, a number of viewings of one or more pieces of furniture, or a browsing history of pieces of furniture.

27. The interior design system of claim 23, wherein the project design engine selects the combination of design elements based on client-designer interactions or on a browsing history of design elements.

28. The interior design system of claim 23, further comprising a client shopping cart displaying a list of selected design elements.

29. The interior design system of claim 28, wherein at least one selected design element includes information retrieved from a third-party data provider.

30. A method of interior design, the method comprising:
receiving a client style;
receiving a client preference;
receiving a design project profile; and
executing a routine on a computing processor to determine a project design based on the client style, the client preference, and the project profile, the routine comprising executing a search heuristic on a collection of possible combinations of design elements and selecting a combination of design elements based on a probability of combination using the client style, the client preference, and the project profile.

31. The method of claim 30, wherein at least one of the client style, the client preference, or the project profile comprises a programmatic object stored in non-transitory memory and having one or more properties.

32. The method of claim 30, further comprising:
displaying a series of design elements;
receiving a user style input with respect to each design element; and
determining the client style based on the user style inputs.

33. The method of claim 32, further comprising receiving a client ranking of each design element and determining the client style based a weighted average of the ranked design elements.

34. The method of claim 30, wherein the client preference comprises at least one of a weighted list of client styles, a budget range, a maximum budget threshold, a minimum budget thresholds, a client income, a client family status, a client family size, a number of viewings of one or more pieces of furniture, or a browsing history of pieces of furniture.

35. The method of claim 30, further comprising selecting the combination of design elements based on client-designer interactions or on a browsing history of design elements.

36. A method of matching a client and a designer for collaborative interior design, the method comprising:
displaying on a graphical user interface a series of images, each image having one or more associated tags;
receiving at least one image selection from the client;
associating the one or more tags associated with the at least one image selection with the client;
receiving profiles of designers, each designer profile having one or more associated tags;
executing a routine on a computing processor that compares the tags associated with the client with the tags associated with each designer profile to determine a compatibility with at least one designer; and
displaying on the graphical user interface a list of one or more compatible designers.

37. The method of claim 36, wherein the routine determines the compatibility between the client and the designers based on a number of common tags associated with the client and the profiles of the designers.

38. The method of claim 36, further comprising executing a routine on a computing processor that determines a client style based on the tags associated with the client.

39. The method of claim 38, further comprising
displaying on the graphical user interface:
a first list of design elements retrieved from remote third-party data sources; and
a second list of design elements retrieved from a data source of a service provider;
receiving a placement of a design element from one of the design element lists in an interactive view of the graphical user interface by the designer;
displaying an arrangement of design elements placed in the interactive view;
executing on a computing processor an information acquisition routine that determines purchasing information for design elements of the first list placed in the interactive view; and
displaying a shopping list populated with at least some of the design elements placed in the interactive view.

40. The method of claim 39, further comprising displaying on the graphical user interface a third list of design elements, each having a style matching the client style.

41. The method of claim 40, further comprising receiving images captured by the designer and displaying a fourth list of design elements, the list comprising the received uploaded images.

42. The method of claim 39, wherein displaying the first or second list of design elements comprises design elements identified as liked-elements by the client.

43. The method of claim 39, further comprising receiving information from the remote third-party data sources regarding at least one of a price, a color, a color pallet, or dimensions.

44. The method of claim 39, wherein displaying the shopping list comprises:
acquiring purchasing information from the remote third-party data source; and
displaying on the graphical user interface an option to view the acquired purchasing information.

45. The method of claim 39, further comprising capturing an image of the interactive view.
